(19) United States
(12) Patent Application Publication
(10) Pub. No.: US 2025/0371616 A1
(43) Pub. Date: Dec. 4, 2025

(54) SYSTEMS AND METHODS FOR CURRENCY EXCHANGES USING A LEDGER ARCHITECTURE

(71) Applicant: Wells Fargo Bank, N.A., San Francisco, CA (US)

(72) Inventors: Matthew Mullin Shepherd, Charlotte, NC (US); Nathaniel C. Eutsler, San Francisco, CA (US); Daniel G. Vogt, New York, NY (US); Piers Varley, San Francisco, CA (US); Yazmin Hiraoka, San Francisco, CA (US); Natarajan Sivakumar, San Francisco, CA (US)

(73) Assignee: Wells Fargo Bank, N.A., San Francisco, CA (US)

(21) Appl. No.: 18/731,714

(22) Filed: Jun. 3, 2024

(51) Int. Cl. G06Q 40/04; G06Q 20/36

(52) U.S. Cl. CPC G06Q 40/04; G06Q 20/3674

(57) ABSTRACT

Various examples, systems and methods are disclosed relating to managing currency exchanges. One system is a data processing system including memory and one or more processing circuits configured to identify one or more assets of an asset class corresponding to an asset grouping framework and generate one or more smart contracts including executable code to monitor an off-chain condition of the one or more assets and exchanges rates. The one or more processing circuits are further configured to broadcast the one or more smart contracts to one or more distributed ledgers and receive, from the one or more smart contracts, an indication the off-chain condition is satisfied. The one or more processing circuits are further configured to process an exchange conversion from the first currency to the second currency based on the current exchange rate and transferring the second currency to a wallet of the receiving party.

### TECHNICAL FIELD

The present implementations relate generally to exchanges, and more particularly to foreign currency exchanges and the settlement of funds in a multi-currency environment. Additionally, the present implementations relate generally to the integration of data retrieval and smart contract execution across distributed ledgers.

### BACKGROUND

In a networked environment such as the internet, users and entities such as individuals, financial institutions, and multinational corporations engage in frequent transactions involving multiple currencies. These transactions can represent a variety of financial operations, including investments, payments, and financial securities trading. As the volume of global transactions continues to increase and the demand for expedited processing rises, improving the speed, security, and efficiency of these currency exchanges may be important.

### SUMMARY

One embodiment relates to a method of managing currency exchanges. The method can include identifying, by one or more processing circuits, one or more assets of an asset class corresponding to an asset grouping framework. The one or more assets can correspond to a right to performance in a first currency from one or more entities. The one or more assets can include one or more distribution parameters corresponding to a distribution in a second currency to a receiving party based on a predefined distribution schedule. The method can include generating, by the one or more processing circuits, one or more smart contracts including executable code to monitor an off-chain condition of the one or more assets and exchanges rates between the first currency and the second currency. The off-chain condition can correspond to a plurality of access locations to a plurality of off-chain data feeds accessible for monitoring by the one or more smart contracts. The method can include broadcasting, by the one or more processing circuits, the one or more smart contracts to one or more distributed ledgers. The broadcasting can include propagating the one or more smart contracts to a plurality of network nodes through a consensus mechanism. The method can include receiving, by the one or more processing circuits from the one or more smart contracts, an indication the off-chain condition is satisfied. The indication can include a current exchange rate between the first currency and the second currency. The indication further includes smart contract validation information corresponding to at least one timestamp and at least one source verification of the plurality of off-chain data feeds. The method can include, in response to the indication by the one or more smart contracts, processing, by the one or more processing circuits, an exchange conversion from the first currency to the second currency based on the current exchange rate, processing the exchange conversion includes updating a plurality of ledger balances and to reflect a pending exchange and temporarily locking exchange funds. The method can include transferring, by the one or more processing circuits, the second currency to a wallet of the receiving party, transferring includes validating a wallet credential of the receiving party and executing a confirmed ledger exchange to finalize the pending exchange.

In some implementations, identifying the one or more assets includes securitizing, by the one or more processing circuits, the one or more assets, determining, by the one or more processing circuits, a projected distribution at the predefined distribution schedule of the one or more assets, the projected distribution is stored in the off-chain condition on the one or more distributed ledgers, the projected distribution is in the second currency, transmitting, by the one or more processing circuits, the projected distribution at the predefined distribution schedule in the second currency to a receiving party computing system, and receiving, by the one or more processing circuits, a signed agreement corresponding to the projected distribution and the predefined distribution schedule in the second currency. In some implementations, a first smart contract of the one or more smart contracts monitors the one or more assets on a first ledger of the one or more distributed ledgers, a second smart contract of the one more ore smart contract monitors the exchange rates on a second ledger of the one or more distributed ledgers, and the executable code is compatible with the first ledger and the second ledger.

In some implementations, a first smart contract of the one or more smart contracts monitors the one or more assets on a first ledger of the one or more distributed ledgers, a second smart contract of the one more ore smart contract monitors the exchange rates on the first ledger of the one or more distributed ledgers, the executable code is compatible with the first ledger. In some implementations, the method further includes determining, by the one or more processing circuits, a first access location of the plurality of access locations of a first data feed of the plurality of off-chain data feeds corresponding to the one or more assets and determining, by the one or more processing circuits, a second access location of the plurality of access locations of a second data feed of the plurality of off-chain data feeds corresponding to the exchanges rates between the first currency and the second currency.

In some implementations, the method further includes locking, by the one or more processing circuits, the current exchange rate prior to processing the exchange conversion by capturing and recording the current exchange rate at a point in time determined by the one or more smart contracts, capturing the current exchange rate includes querying one or more of the plurality of off-chain data feeds, and locking includes embedding the current exchange rate into a transaction block that is verified and appended to the one or more distributed ledgers and processing the exchange conversion to the second currency is further responsive to satisfying the one or more distribution parameters of the receiving party, the one or more distribution parameters include at least one of a minimum distribution value, a predefined transaction frequency, or a specific date of transfer. In some implementations, the method further includes determining, by the one or more processing circuits, the one or more distribution parameters of the receiving party based on inputting historical exchange data and a receiving party profile into a trained artificial intelligence (AI) model and receiving the one or more distribution parameters as an output.

In some implementations, generating the one or more smart contracts further include generating a future contract for a future exchange rate at the predefined distribution schedule, the future contract locks the future exchange rate for the exchange conversion, the current exchange rate is the future exchange rate of the future contract. In some implementations, broadcasting includes signing and verifying the one or more smart contracts before storing the one or more smart contracts on the one or more distributed ledgers and transferring the second currency to the wallet of the receiving party includes performing, using a cross-ledger protocol, a cross-ledger exchange from the one or more distributed ledgers to the wallet on a different distributed ledger, the cross-ledger protocol includes initiating a cryptographic validation confirming the transfer on the one or more distributed ledgers and the different distributed ledger. In some implementations, the first currency is at least one of a first type of fiat currency, digital currency, utility token, or cryptocurrency, the second currency is at least one of a second type of fiat currency, digital currency, utility token, or cryptocurrency, temporarily locking the exchange funds includes generating an escrow condition in the one or more distributed ledgers and marking the exchange funds as unavailable for other exchanges until the transfer or a cancelation event is confirmed.

Another embodiment relates to a system. The system may include a data processing system including memory and one or more processing circuits configured to identify one or more assets of an asset class corresponding to an asset grouping framework, the one or more assets corresponds to a right to performance in a first currency from one or more entities, and the one or more assets include one or more distribution parameters corresponding to a distribution in a second currency to a receiving party based on a predefined distribution schedule. The one or more processing circuits can be configured to generate one or more smart contracts including executable code to monitor an off-chain condition of the one or more assets and exchanges rates between the first currency and the second currency, the off-chain condition correspond to a plurality of access locations to a plurality of off-chain data feeds accessible for monitoring by the one or more smart contracts. The one or more processing circuits can be configured to broadcast the one or more smart contracts to one or more distributed ledgers, broadcasting includes propagating the one or more smart contracts to a plurality of network nodes through a consensus mechanism. The one or more processing circuits configured to receive, from the one or more smart contracts, an indication the off-chain condition is satisfied, the indication includes a current exchange rate between the first currency and the second currency, the indication further includes smart contract validation information corresponding to at least one timestamp and at least one source verification of the plurality of off-chain data feeds. The one or more processing circuits configured to in response to the indication by the one or more smart contracts, process an exchange conversion from the first currency to the second currency based on the current exchange rate, processing the exchange conversion includes updating a plurality of ledger balances and to reflect a pending exchange and temporarily locking exchange funds. The one or more processing circuits configured to transferring, by the one or more processing circuits, the second currency to a wallet of the receiving party, transferring includes validating a wallet credential of the receiving party and executing a confirmed ledger exchange to finalize the pending exchange.

In some implementations, identifying the one or more assets includes securitizing the one or more assets, determining a projected distribution at the predefined distribution schedule of the one or more assets, the projected distribution is stored in the off-chain condition on the one or more distributed ledgers, the projected distribution is in the second currency, transmitting the projected distribution at the predefined distribution schedule in the second currency to a receiving party computing system, and receiving a signed agreement corresponding to the projected distribution and the predefined distribution schedule in the second currency. In some implementations, a first smart contract of the one or more smart contracts monitors the one or more assets on a first ledger of the one or more distributed ledgers, a second smart contract of the one more ore smart contract monitors the exchange rates on a second ledger of the one or more distributed ledgers, and the executable code is compatible with the first ledger and the second ledger. In some implementations, a first smart contract of the one or more smart contracts monitors the one or more assets on a first ledger of the one or more distributed ledgers, a second smart contract of the one more ore smart contract monitors the exchange rates on the first ledger of the one or more distributed ledgers, and the executable code is compatible with the first ledger.

In some implementations, the one or more processing circuits further configured to determine a first access location of the plurality of access locations of a first data feed of the plurality of off-chain data feeds corresponding to the one or more assets and determine a second access location of the plurality of access locations of a second data feed of the plurality of off-chain data feeds corresponding to the exchanges rates between the first currency and the second currency. In some implementations, the one or more processing circuits further configured to lock the current exchange rate prior to processing the exchange conversion by capturing and recording the current exchange rate at a point in time determined by the one or more smart contracts, capturing the current exchange rate includes querying one or more of the plurality of off-chain data feeds, and locking includes embedding the current exchange rate into a transaction block that is verified and appended to the one or more distributed ledgers and processing the exchange conversion to the second currency is further responsive to satisfying the one or more distribution parameters of the receiving party, the one or more distribution parameters include at least one of a minimum distribution value, a predefined transaction frequency, or a specific date of transfer.

In some implementations, the one or more processing circuits further configured to determine the one or more distribution parameters of the receiving party based on inputting historical exchange data and a receiving party profile into a trained artificial intelligence (AI) model and receiving the one or more distribution parameters as an output. In some implementations, generating the one or more smart contracts further include generating a future contract for a future exchange rate at the predefined distribution schedule, the future contract locks the future exchange rate for the exchange conversion, the current exchange rate is the future exchange rate of the future contract.

Still another embodiment relates to a non-transitory computer readable medium (CRM) including one or more instructions stored thereon that, when executed by one or more processing circuits, cause the one or more processing circuits to perform operations including identifying one or more assets of an asset class corresponding to an asset grouping framework, the one or more assets corresponds to a right to performance in a first currency from one or more entities, and the one or more assets include one or more distribution parameters corresponding to a distribution in a second currency to a receiving party based on a predefined distribution schedule, generating one or more smart contracts including executable code to monitor an off-chain condition of the one or more assets and exchanges rates between the first currency and the second currency, the off-chain condition correspond to a plurality of access locations to a plurality of off-chain data feeds accessible for monitoring by the one or more smart contracts, the indication further includes smart contract validation information corresponding to at least one timestamp and at least one source verification of the plurality of off-chain data feeds, broadcasting the one or more smart contracts to one or more distributed ledgers, broadcasting includes propagating the one or more smart contracts to a plurality of network nodes through a consensus mechanism, receiving, from the one or more smart contracts, an indication the off-chain condition is satisfied, the indication includes a current exchange rate between the first currency and the second currency, the indication further includes smart contract validation information corresponding to at least one timestamp and at least one source verification of the plurality of off-chain data feeds, in response to the indication by the one or more smart contracts, processing an exchange conversion from the first currency to the second currency based on the current exchange rate, processing the exchange conversion includes updating a plurality of ledger balances and to reflect a pending exchange and temporarily locking exchange funds and transferring the second currency to a wallet of the receiving party, transferring includes validating a wallet credential of the receiving party and executing a confirmed ledger exchange to finalize the pending exchange.

In some implementations, the one or more instructions, when executed by the one or more processing circuits, further cause the one or more processing circuits to perform operations including securitizing the one or more assets, determining a projected distribution at the predefined distribution schedule of the one or more assets, the projected distribution is stored in the off-chain condition on the one or more distributed ledgers, the projected distribution is in the second currency. In some implementations, the one or more instructions, when executed by the one or more processing circuits, further cause the one or more processing circuits to perform operations including transmitting the projected distribution at the predefined distribution schedule in the second currency to a receiving party computing system receiving a signed agreement corresponding to the projected distribution and the predefined distribution schedule in the second currency.

Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers indicate identical, functionally similar, and/or structurally similar elements.

FIG. 1A depicts an example system, according to some implementations.

FIG. 1B depicts another example system, according to some implementations.

FIG. 2 depicts a block diagram illustrating an example computing system for use in the various implementations described herein.

FIG. 3 depicts an example exchange architecture, according to some implementations.

FIG. 4 depicts a method to manage currency exchanges, according to some implementations.

It will be recognized that some or all of the FIGS. are schematic representations for purposes of illustration. The FIGS. are provided for the purpose of illustrating one or more embodiments with the explicit understanding that they will not be used to limited the scope of the meaning the claims.

### DETAILED DESCRIPTION

The present implementations will now be described in detail with reference to the drawings, which are provided as illustrative examples of the implementations so as to enable those skilled in the art to practice the implementations and alternatives apparent to those skilled in the art. Notably, the Figures and examples below are not meant to limit the scope of the present implementations to a single implementation, but other implementations are possible by way of interchange of some or all of the described or illustrated elements. Moreover, where certain elements of the present implementations can be partially or fully implemented using known components, only those portions of such known components that are necessary for an understanding of the present implementations will be described, and detailed descriptions of other portions of such known components will be omitted so as not to obscure the present implementations. Implementations described as being implemented in software should not be limited thereto, but can include implementations implemented in hardware, or combinations of software and hardware, and vice-versa, as will be apparent to those skilled in the art, unless otherwise specified herein. In the present specification, an implementation showing a singular component should not be considered limiting; rather, the present disclosure is intended to encompass other implementations including a plurality of the same component, and vice-versa, unless explicitly stated otherwise herein. Moreover, any term in the specification or claims should not be ascribed an uncommon or special meaning unless explicitly set forth as such. Further, the present implementations encompass present and future known equivalents to the known components referred to herein by way of illustration.

This disclosure relates to systems, computer-readable media, and methods for managing currency exchanges, particularly using a distributed ledger technology (DLT) architecture for real-time or near real-time settlement. As described herein, the disclosed systems and methods can identify and securitize multiple currencies, defining conditions for these grouped currencies to provide automatic exchanges under specific conditions, such as meeting a predefined exchange rate or according to a predefined disbursement schedule. The technological improvements can include, for example, the implementations of smart contracts to monitor and enforce these conditions dynamically, increasing the fungibility and interoperability of different currencies and exchange systems.

Typically, currency management processes are manual and involve time-consuming steps that may lead to delays and errors. These processes are particularly inefficient at large scales where real-time transaction needs and multiple currencies are involved. Manual approaches also generally lack real-time monitoring and rapid settlement capabilities, making them unsuitable for today's fast-paced financial environments. In response, some systems employ SWIFT, which transmits messages without actual value transfer. That is, traditional SWIFT systems can facilitate communication between banks and financial institutions about transaction details but do not directly handle the transfer of funds. This indirect approach can lead to delays between transaction initiation and completion, dependency on intermediary processing, and increased risk of errors and fraud.

The DLT-based systems and methods described herein, in contrast, provides direct value transfer across distributed ledgers, thereby eliminating the need for intermediary message transmissions and the associated processing delays. By using smart contracts that automatically execute based on predefined conditions such as exchange rates or specific time triggers, the systems and methods can communicate the details of transactions and execute the transfer of value in real-time or near real-time. Additionally, to address the technical problems, the described systems and methods employ an improved DLT-based approach that integrates smart contracts for automating currency exchanges. These smart contracts are designed to execute automatically when predefined conditions, such as predefined favorable exchange rates or specific time conditions, are met. This implementation improves efficiency by minimizing manual interventions and errors, providing secure transactions across various currencies.

The described technical improvement to instantly settle transactions upon satisfying the contractual conditions provides a material advantage by improving the speed and efficiency of financial exchanges. It also reduces transaction costs and operational risks, improves liquidity management, and enhances overall financial security. Furthermore, by maintaining an immutable record of some or all transactions on the distributed ledger, the systems and methods provide improved auditability and compliance, aspects that are less efficiently handled by traditional messaging systems. Moreover, the architecture supports improved monitoring and auditing capabilities, providing real-time tracking of some or all transactions. Furthermore, the systems and methods described herein may dynamically handle multiple currencies and exchange rates through a unified platform reduces the complexity and computational overhead associated with traditional currency exchange processes. These and other features and benefits are described more fully herein below.

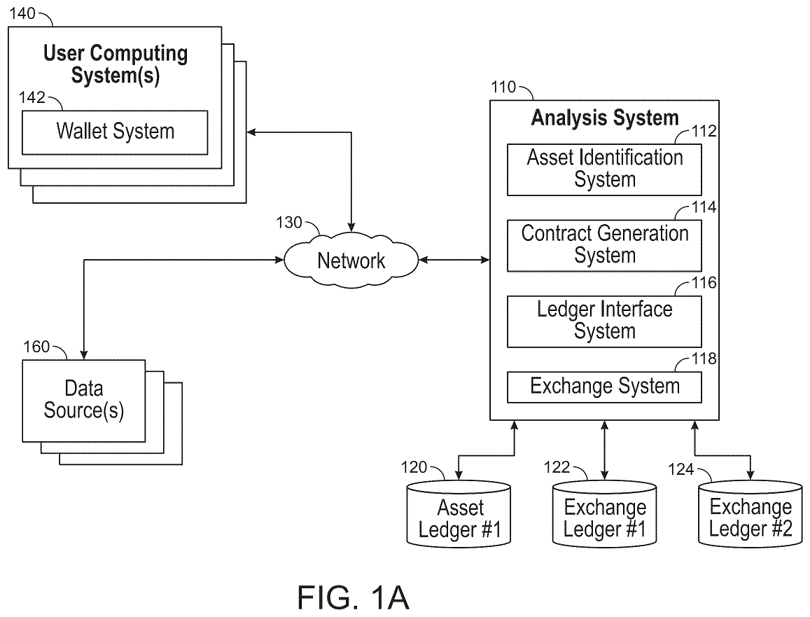

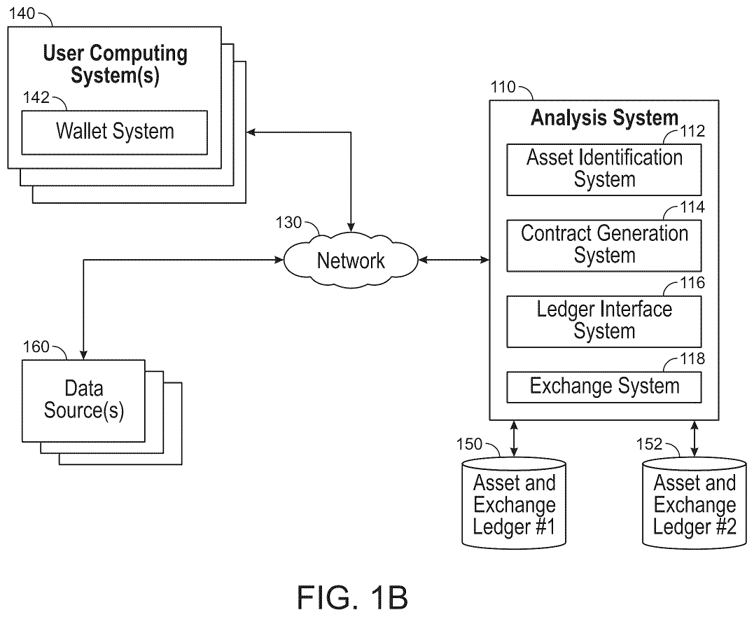

Referring now to FIG. 1A, a block diagram of an example system is shown, according to some embodiments. The example system is shown to include analysis computing system 110, asset ledger 120, exchange ledger 122, exchange ledger 124, user computing system 140, and data sources 160. In other implementations, more, fewer, and/or different components may be included in the system. The components of the example system may be connected, or in communication, via a network 130. Network 130 may include computer networks such as the Internet, local, wide, metro or other area networks, intranets, satellite networks, other computer networks such as voice or data mobile phone communication networks, combinations thereof, or any other type of electronic communications network. Network 130 may include or constitute a display network. In some embodiments, network 130 facilitates secure communication between components of example system. As a non-limiting example, network 130 may implement transport layer security (TLS), secure sockets layer (SSL), hypertext transfer protocol secure (HTTPS), and/or any other secure communication protocol. It should be noted that the number and type of components shown are merely illustrative, and in some embodiments, implementations of the example system may have additional, fewer, and/or different components than those illustrated in FIG. 1A and FIG. 1B.

Referring generally to FIG. 1A, the analysis system 110 can be structured to facilitate settlement of funds (e.g., foreign exchange transactions). The analysis system 110 can use distributed ledger technology (DLT) to track and manage foreign currencies by providing a shared view of currency data sources and databases. Within the system architecture, various ledgers such as asset ledger 120, exchange ledger 122, and potentially combined asset and exchange ledgers like asset and exchange ledger 150 and 152, can function to record transactions and manage assets and currency exchanges. The ledgers can be configured to interact with the analysis system 110. The implementation of ledgers can support real-time (or near real-time) reconciliation of transactions across different currencies and/or jurisdictions, facilitating a continuous or substantially continuous settlement process. In some implementations, the analysis system 110 can utilize smart contracts deployed across these ledgers to enforce transaction rules and conditions, preventing issues such as double spending and providing compliance with agreed-upon exchange rates and other transaction conditions. The smart contracts can be used to execute transactions when predefined conditions are met, such as reaching a certain exchange rate. For example, the smart contracts can support the securitization of multiple currencies and manage layers of securitization for different currency types and denominations. The analysis system 110 can be associated with, owned by, managed by, controlled by, etc. a provider institution, in some embodiments. The provider institution can be a financial institution, such as a bank, a brokerage firm, an investment fund, or any other entity involved in the management, exchange, or settlement of financial assets.

In general, the one or more processing circuits of the analysis system 110 can communicate with ledgers via the addresses (public or private) of the source and destination ledgers (or digital wallets). Each address may be a unique sequence of randomized (or pseudo-randomized) numerical digits, characters, punctuation, whitespace, code (e.g., QR) or symbols. For example, an address may be a randomized 256-bit sequence. An address can be associated with one or more digital assets. In some arrangements, addresses may be shared across network 130. In various arrangements, the analysis system 110 and/or wallet system 142 may be allowed to access address information of various ledgers including, but not limited to, asset ledger 120 addresses, exchange ledger 122 addresses, exchange ledger 124 addresses, asset and exchange ledger 150 addresses, and asset and exchange ledger 152 addresses. For example, the ledger interface system 116 of the one or more processing circuits can establish a secure connection over a secure network. That is, the secure connection can allow for secure communication and secure transfer of data to/from the one or more processing circuits over a secure network (e.g., secure VPN connection, secure wired connection, and so on) utilizing a secure network protocol (e.g., Secure Shell (SSL), Kerberos, IPSec, Secure Sockets Layer (SSL), Hypertext Transfer Protocol Secure (HTTPS), and so on).

In some implementations, the ledgers described herein may be internal or external to the analysis system 110. Internal and external ledgers, such as asset ledger 120 and exchange ledger 122, can be managed by the analysis system 110, facilitating data exchange and transaction processing within a controlled environment. These ledgers can be implemented using various DLT technologies, such as blockchain, hashgraph, or directed acyclic graph (DAG), and can interface with the analysis system 110. Externally integrated ledgers, which may include third-party blockchain networks or decentralized finance (DeFi) platforms, can be managed using secure APIs or standardized communication protocols. Both types of integrations can handle ledger-specific operations, such as consensus mechanisms, transaction validation, and smart contract execution, to maintain data integrity and operational efficiency. The analysis system 110 can employ middleware or gateway solutions to bridge internal and external ledgers, facilitating real-time synchronization and transaction reconciliation across different ledger ecosystems.

In one beneficial implementation, the analysis system 110 can be used to replace traditional messaging systems like SWIFT or portions thereof, which transmits financial messages without transferring value. Instead, the analysis system 110 directly transfers value on the blockchain, recording every or nearly every transaction immutably to provide integrity throughout the transaction lifecycle. The analysis system 110 can use APIs to facilitate communication between the ledgers and the analysis system 110. In some implementations, when transactions span multiple time zones, the analysis system 110 can utilize identifiers to mark transactions with specific timestamps, ensuring that the settlement is recognized on the correct day across some or all relevant jurisdictions. The identifier can be used to prevent arbitrage by ensuring that the timing of fund transfers is accurately recorded and recognized according to the local time of each involved party.

The network 130 can facilitate communication between various nodes, such as the analysis system 110, the user computing system 140, and the data sources 160. In some embodiments, data flows through the network 130 from a source node to a destination node as a flow of data packets, e.g., in the form of data packets in accordance with the Open Systems Interconnection (OSI) layers. A flow of packets may use, for example, an OSI layer-4 transport protocol such as the User Datagram Protocol (UDP), the Transmission Control Protocol (TCP), or the Stream Control Transmission Protocol (SCTP), transmitted via the network 130 layered over a OSI layer-3 network protocol such as Internet Protocol (IP), e.g., IPv4 or IPv6. The network 130 can be composed of various network devices (nodes) that are communicatively linked to form one or more data communication paths between participating devices. Each networked device includes at least one network interface for receiving and/or transmitting data, typically as one or more data packets. An illustrative network 130 is the Internet; however, other networks may be used. The network 130 may be an autonomous system (AS), i.e., a network that is operated under a consistent unified routing policy (or at least appears to be from outside the AS network) and is generally managed by a single administrative entity (e.g., a system operator, administrator, or administrative group).

Generally, the analysis system 110, user computing system 140, and data sources 160 can include one or more logic devices, which can be one or more computing devices equipped with one or more processing circuits that run instructions stored in a memory device to perform various operations. The processing circuit can be made up of various components such as a microprocessor, an ASIC, or an FPGA, and the memory device can be any type of storage or transmission device capable of providing program instructions. The instructions may include code from various programming languages commonly used in the industry, such as high-level programming languages, web development languages, and systems programming languages. The analysis system 110, user computing system 140, and data sources system 160 may also include one or more databases for storing data, such as asset ledger 120, exchange ledger 122, and/or exchange ledger 124, that receive and provide data to other systems and devices on the network 130.

As will be discussed in greater detail below, the analysis system 110 may be configured to manage and facilitate currency exchanges using one or more ledgers. That is, the ledgers (e.g., public permissioned, public permissionless, private permissioned, and/or private permissionless) may be implemented using various types of ledger technologies, including blockchain, hashgroup, directed acyclic graph (DAG), holochain, tempo, and other ledger technologies, to which the analysis system 110 may manage and facilitate currency exchanges on. The analysis system 110 can interact with the various systems of example system over network 130. In some embodiments, the analysis system 110 can include one or more processing circuits, including processor(s) and memory. The memory may have instructions stored thereon that, when executed by processor(s), cause the one or more processing circuits to perform the various operations described herein. The operations described herein may be implemented using software, hardware, or a combination thereof. The processor(s) may include a microprocessor, ASIC, FPGA, etc., or combinations thereof. In many implementations, processor(s) may be a multi-core processor or an array of processors. Memory may include, but is not limited to, electronic, optical, magnetic, or any other storage devices capable of providing processor(s) with program instructions. The instructions may include code from any suitable computer programming language. In some embodiments, the analysis system 110 can include an asset identification system 112, a contract generation system 114, a ledger interface system 116, and an exchange system 118. In some embodiments, the analysis system 110 may be a backend server configured to support and facilitate the functionality and implementations described herein. For example, a backend server may be a database server, application servers, and/or transaction processing servers.

The asset identification computing system 112 (shown as “asset identification system 112”) is structured or configured to identify one or more assets of an asset class of an asset grouping framework. Generally, the asset identification system 112 can be a component, such as one or more processing circuits, structured or configured to identify and securitize assets according to specific classification criteria. For example, the asset identification system 112 may automatically identify and categorize securities, such as bonds or loans, based on their currency and payment structures. In some implementations, an asset class can be a grouping of investments that exhibit similar financial characteristics and/or behave similarly in the marketplace. For example, foreign currencies, government bonds, and corporate debts may each represent different asset classes, each with distinct rules and functionality on asset ledger 120. The asset identification computing system 112. In some embodiments, the asset identification computing system 112 can include one or more processing circuits, including processor(s) and memory. The memory may have instructions stored thereon that, when executed by processor(s), cause the one or more processing circuits to perform the various operations described herein. The operations described herein may be implemented using software, hardware, or a combination thereof. The processor(s) may include a microprocessor, ASIC, FPGA, etc., or combinations thereof. In many implementations, processor(s) may be a multi-core processor or an array of processors. Memory may include, but is not limited to, electronic, optical, magnetic, or any other storage devices capable of providing processor(s) with program instructions. The instructions may include code from any suitable computer programming language.

In some implementations, the asset grouping framework organizes assets into structured groups for management and/or operational processes. For example, the asset grouping framework may group different types of securities, such as bonds and stocks, based on their risk profile and/or expected return. In some implementations, assets can be items of value that can be securitized, traded, or used to fulfill financial obligations. Assets can be financial instruments that are securitized, facilitating their cash or currency flows to be structured according to specific investor requirements. For example, assets may include loans originated by U.S. consumers, where the principal and interest payments are initially in U.S. dollars but are contractually promised to be paid out to Japanese investors in yen following securitization. In some implementations, the asset identification system 112 is further structured or configured to securitize assets by converting the one or more assets into securities. For example, the asset identification system 112 may pool the assets into tradeable financial instruments (e.g., as securities) which can then be bought and sold on financial markets.

In some implementations, the right to performance in a first currency can be an entitlement to receive payments or other financial returns denominated in a specific currency as stipulated in the terms of an asset. For example, a bond may include the right to receive interest payments in U.S. dollars. In some implementations, entities can be the parties obligated to perform under the terms of a financial instrument. Entities can be obligors or mortgagors responsible for fulfilling the financial obligations defined by the assets, such as paying principal and interest. For example, a U.S. consumer who has taken out a mortgage may be the entity responsible for making the scheduled payments that are then redirected to investors in another currency as stipulated by the terms of the securitized asset. In some implementations, the asset identification system 112 can analyze data related to the assets to determine a projected distribution at the predefined distribution schedule. For example, the asset identification system 112 may analyze historical performance, market conditions, and other relevant information.

In some implementations, distribution parameters can define how and when distributions, like dividends or interest payments, are made to investors. For example, the parameters can identify that interest payments on a multi-currency bond are to be made semiannually and converted to Japanese yen at the prevailing exchange rate. In some implementations, the distribution in a second currency can include the payment of dividends, interest, or principal in a currency different (or the same based on the investor preference) from the one in which the asset primarily operates. For example, a bond issued in U.S. dollars may distribute returns in euros, depending on the investor's preference or contractual agreements. In some implementations, the receiving party can be the individual and/or entity entitled to receive distributions from an asset. For example, this may be an investor who receives periodic interest payments from a bond they hold, converted into their preferred currency. In some implementations, the predefined distribution schedule can be rules or parameter outlining the times at which distributions are made to investors, such as monthly, quarterly, or annually. For example, the predefined distribution schedule may dictate that conversions and payments from U.S. dollars to Japanese yen for a particular bond occur every six months.

In some implementations, the asset identification system 112 can send or transfer the projected distribution electronically to the user computing system 140. For example, the asset identification system 112 may transmit the projected distribution at the predefined distribution schedule in the second currency type to a receiving party computing system (e.g., user computing system 140). In this example, transmission may occur through secure communication channels to certify the accuracy and integrity of the data. In some implementations, the asset identification system 112 can receive a signed agreement corresponding to the projected distribution and the predefined distribution schedule in the second currency type from the receiving party computing system. For example, the agreement may serve as confirmation of the terms and conditions of the distribution.

The contract generation computing system 114 (shown as “contract generation system 114) is structured or configured to generate one or more smart contracts including executable code to monitor an off-chain condition of the asset and exchange rates between the first currency and the second currency. For example, the contract generation system 114 may use predefined algorithms to automatically generate smart contracts customized to specific asset conditions and currency exchange parameters. In some implementations, if the ledger interface system 116 detects a change in asset value or a significant shift in exchange rates, the contract generation system 114 may generate corresponding smart contracts to initiate necessary actions. For example, the smart contracts may contain embedded logic to monitor various off-chain data feeds accessible for tracking the asset's conditions and exchange rates, with one smart contract implemented for assets on asset ledger 120 and another implemented for exchange rates on exchange ledger 122, both blockchains storing the smart contracts. For example, the smart contracts may track off-chain data feeds (e.g., data sources 160) providing real-time updates on asset performance and currency exchange rates to the ledger interface system 116, with one smart contract communicating changes to the asset ledger 120 and another communicating rates to the exchange ledger 122. In some embodiments, the contract generation computing system 114 can include one or more processing circuits, including processor(s) and memory. The memory may have instructions stored thereon that, when executed by processor(s), cause the one or more processing circuits to perform the various operations described herein. The operations described herein may be implemented using software, hardware, or a combination thereof. The processor(s) may include a microprocessor, ASIC, FPGA, etc., or combinations thereof. In many implementations, processor(s) may be a multi-core processor or an array of processors. Memory may include, but is not limited to, electronic, optical, magnetic, or any other storage devices capable of providing processor(s) with program instructions. The instructions may include code from any suitable computer programming language.

In some implementations, the executable code can be software, such as one or more scripts, that can be run on the analysis system 110 or ledgers (e.g., blockchain network) to perform various functions. For example, the executable code within a smart contract may include functions to fetch the latest exchange rates from a data source and execute currency exchanges for a distribution of the securitized asset. In some implementations, an off-chain condition can be any prerequisite or criterion for action that depends on data or events outside the ledgers. The various contracts can monitor these conditions by accessing external data through specific interfaces or APIs. In some implementations, an exchange rate can be the relative value of two different currencies, which can fluctuate based on market conditions. The rates can be monitored by smart contracts to optimize or trigger transactions. For example, a smart contract may be set to execute a financial swap between euros and dollars when a distribution in dollars is needed, based on data retrieved from external sources. In some implementations, a plurality of access locations can be multiple points or interfaces through which data can be retrieved or accessed by the analysis system 110. These locations can be distributed across various systems or platforms. For example, a smart contract may contain several predefined access points to different financial databases to provide continuous monitoring of exchange rates (e.g., in case one data source becomes unavailable).

In some implementations, a first smart contract of the one or more smart contracts monitors the asset on asset ledger 120 of the one or more ledgers (e.g., a blockchain storing the smart contract), and a second smart contract of the exchange ledger 122 may communicate with external sources such as Oracles to monitor the exchange rate. For example, the first smart contract may continuously check the asset ledger 120 for updates related to the asset's status or conditions, while the second smart contract may interact with external Oracles to retrieve real-time exchange rate data. Currency conversion processes based on current exchange rates may be initiated when a disbursement is scheduled, triggered by the first smart contract based on the asset ledger's indications.

In some implementations, alternatively or in combination, a first smart contract of the one or more smart contracts communicates with external sources such as Oracles to monitor both the asset and exchange rates, while a second smart contract of the one or more smart contract also interacts with external sources to monitor the exchange rate. For example, in an alternative configuration, a single smart contract may be designed to communicate with external Oracles to monitor both the asset and exchange rates within a unified ledger system. For example, if the asset and exchange ledgers are combined into an asset and exchange ledger system 150 (shown in FIG. 1B), one or more smart contracts may facilitate both asset-related updates and exchange rate fluctuations within the same environment, using external data sources for information and initiating currency conversion processes when a disbursement is scheduled.

In some implementations, the contract generation system 114 can generate one or more smart contracts including executable code to monitor an off-chain condition of the asset and exchange rates between the first currency and the second currency. The smart contracts can employ blockchain technology to autonomously execute predefined actions based on real-time data feeds and predetermined conditions. For example, if a smart contract detects that a predefined exchange rate threshold has been met, the smart contract may automatically trigger a currency conversion transaction between the first and second currencies. In some implementations, an off-chain condition may trigger a predefined event, such as a change in interest rates, the associated smart contract may automatically adjust the asset's parameters or initiate currency conversion processes. For example, the smart contracts may contain logic to monitor various off-chain data feeds (e.g., data sources 160) accessible for tracking the asset's conditions and exchange rates. In some implementations, data sources 160 can be external platforms or services that collect, transmit, and make available the off-chain data used for smart contracts to operate. For example, data sources 160 may be financial data services that provide real-time exchange rates between the euro and the yen. In some implementations, a plurality of off-chain data feeds can include multiple external data sources that provide real-time or near-real-time data for the operation of smart contracts. The data feeds can include financial indices, exchange rates, weather data, and other relevant metrics that influence contract execution. For example, off-chain data feeds may provide current and historical exchange rates from global currency markets.

The ledger interface computing system 116 (shown as “ledger interface system 116”) is structured or configured to manage the deployment and synchronization of smart contracts across multiple distributed ledger technologies (DLT) systems. In some implementations, smart contracts can be self-executing contracts with the terms of the agreement directly written into lines of code. These smart contracts can stored and replicated on asset ledger 120 and exchange ledger 122, which can enforce the contract automatically. For example, a smart contract may automatically execute a currency exchange when a predefined exchange rate is reached. In some implementations, broadcasting can include sending the smart contracts to be stored and executed by multiple nodes. In some implementations, one or more distributed ledgers (e.g., asset ledger 120, exchange ledger 122, exchange ledger 124) can be a collection of digital systems that record asset transactions and exchange rates with cryptography-based technologies across multiple sites, countries, or institutions. In some implementations, a plurality of network nodes can be multiple computers or servers that participate in a network's blockchain infrastructure. Each node can maintain a copy of the entire ledger and participate in the consensus process. In some implementations, the consensus mechanism can be a protocol that verifies exchanges are accurately recorded on the blockchain (e.g., asset ledger 120) by receiving agreement among some or all participating nodes. For example, a consensus mechanism like Proof of Work or Proof of Stake can be used to verify that some or all nodes agree on the state of the ledger before any transactions are confirmed. In some embodiments, the ledger interface computing system 116 can include one or more processing circuits, including processor(s) and memory. The memory may have instructions stored thereon that, when executed by processor(s), cause the one or more processing circuits to perform the various operations described herein. The operations described herein may be implemented using software, hardware, or a combination thereof. The processor(s) may include a microprocessor, ASIC, FPGA, etc., or combinations thereof. In many implementations, processor(s) may be a multi-core processor or an array of processors. Memory may include, but is not limited to, electronic, optical, magnetic, or any other storage devices capable of providing processor(s) with program instructions. The instructions may include code from any suitable computer programming language.

The ledger interface system 116 is structured or configured to broadcast the one or more smart contracts to one or more distributed ledgers (e.g., blockchains, such as asset ledger 120 and exchange ledger 122). The ledger interface system 116 can use a communication protocol to distribute the smart contracts across distributed ledgers. For example, when a financial institution initiates a securitization process involving multiple currencies, the ledger interface system 116 can propagate the corresponding smart contracts to the asset ledger 120 (e.g., asset smart contract) and exchange ledger 122 (e.g., exchange smart contract). In some implementations, the asset ledger 120 and exchange ledger 122 can be a blockchains configured to host and execute the smart contracts broadcasted by the ledger interface system 116. The ledgers (e.g., asset ledger 120, exchange ledger 122, exchange ledger 124) can maintain a synchronized record of the smart contracts. In some implementations, upon receiving new smart contracts from the ledger interface system 116, the asset ledger 120 and/or exchange ledger 122 can validate the authenticity of the smart contracts and distribute them to network nodes for execution. For example, when a bond issuance requires real-time monitoring and execution of exchange transactions, the ledger interface system 116 can broadcast the relevant smart contracts to the asset ledger 120 and exchange ledger 122. That is, the smart contracts can define conditions for currency conversions and settlement of funds, facilitating executions across ledgers and providing improved management of multi-currency transactions.

The asset ledger 120 can be structured or configured as at least one blockchain that can store and manage securitized assets and their corresponding asset smart contracts. The asset ledger 120 can provide a decentralized repository for recording and tracking securitized assets. For example, when a financial institution securitizes a portfolio of loans into a bond, the asset ledger 120 can store the bond's details and associated smart contracts. In some implementations, the exchange ledger 122 can be structured or configured as a blockchain that can store smart contracts for determining exchange rates and facilitating currency exchanges. That is, the exchange ledger 122 can provide a decentralized repository for recording and updating exchange rate data in real-time. For example, when a currency exchange transaction is initiated, smart contracts deployed on the exchange ledger 122 can execute the conversion based on current exchange rates.

The asset ledger 120 can be a blockchain platform structured and configured to record and manage transactions related to securitized assets. The asset ledger 120 can maintain an immutable and transparent record of some or all asset-related transactions. The asset ledger 120 can use cryptographic methods to secure transaction data and controls access based on predefined permissions. The asset ledger 120 can also be configured to store and execute smart contracts that automate the processes of asset management, such as issuing, transferring, and paying out securitized assets. For example, the asset ledger 120 can record and manage a smart contract for a portfolio of auto loans, detailing each loan's origination, terms, performance, and automated payouts in different currencies as dictated by the smart contract terms.

The exchange ledger 122 can be at least one blockchain platform structured and configured to record and manage transactions related currency exchanges as dictated by smart contracts. The exchange ledger 122 can store smart contracts that facilitate currency conversion tasks, using real-time exchange rate data supplied by external data feeds. The exchange ledger 122 can perform automatic execution of currency conversions required by the smart contracts. For example, a smart contract stored on the exchange ledger 122 can automatically process a currency conversion transaction when triggered by a corresponding smart contract on the asset ledger 120, using up-to-date exchange rates from data sources 160.

The data sources 160 can include external platforms or services that provide real-time or near-real-time data for the operation of smart contracts on blockchains such as the asset ledger 120 and exchange ledger 122. These data sources can provide (or make available) a plurality of financial data, including exchange rates, market indices, and performance metrics. Data sources 160 can be integrated through APIs that facilitate secure data retrieval. For example, data sources 160 may supply the current exchange rates that a smart contract on the exchange ledger 122 uses to execute currency conversions. Furthermore, the smart contracts stored on the asset ledger 120 can manage the lifecycle of securitized assets, and the smart contracts on the exchange ledger 122 can manage some or all currency exchange functions, including monitoring and execution based on real-time data provided by data sources 160. The implementations provide automated transactions, reducing manual intervention and improving both the speed and reliability of output operations. For example, when a smart contract on the asset ledger 120 determines that conditions for a currency conversion are met based on asset performance (e.g., quarterly distribution, a scheduled dividend, etc.), the smart contract can trigger another smart contract on the exchange ledger 122 to perform the exchange using the best available rate from data sources 160.

The data sources 160 can include various types of data feeds, such as financial news services, economic indicator reports, and proprietary data streams from financial institutions. These data sources 160 can provide financial data, including interest rates, commodity prices, trading volumes, and geopolitical event updates. Integration of these data sources 160 can be facilitated using data interchange formats such as JSON, XML, or CSV, and secure communication protocols like HTTPS or WebSockets. Data sources 160 can support both push and pull data retrieval mechanisms, facilitating the transmission of updates to the analysis system 110. The data sources 160 can be continuously monitored and validated to maintain data integrity and accuracy. Additionally, data sources 160 may include historical data archives for back-testing and analysis purposes. In some embodiments, the data sources 160 can include one or more processing circuits, including processor(s) and memory. The memory may have instructions stored thereon that, when executed by processor(s), cause the one or more processing circuits to perform the various operations described herein. The operations described herein may be implemented using software, hardware, or a combination thereof. The processor(s) may include a microprocessor, ASIC, FPGA, etc., or combinations thereof. In many implementations, processor(s) may be a multi-core processor or an array of processors. Memory may include, but is not limited to, electronic, optical, magnetic, or any other storage devices capable of providing processor(s) with program instructions. The instructions may include code from any suitable computer programming language.

Referring generally to the securitized assets stored on the asset ledger 120, the securitized assets can be digital tokens or entries on a blockchain of the asset ledger 120. The securitized assets can include metadata that encapsulates some or all or a predefined amount of information about the asset, such as ownership rights, value, and conditions tied to its performance (e.g., income from the asset). In some implementation, an asset or group of assets can be recorded in a data block within the blockchain of the asset ledger 120 (e.g., on-chain). The block can include transaction data related to the asset, such as creation, transfer of ownership, and performance metrics. In some implementations, the smart contracts can be implemented to manage the logic and rules associated with the securitized assets, such as distribution based on performance or changes in ownership. The smart contract code can also be stored on the blockchain of the asset ledger 120 and execute automatically based on predefined conditions.

In some implementations, the asset ledger 120 can track the ownership and performance data of the securitized assets. That is, the asset ledger 120 can facilitate some or all transactions related to the asset itself. In some implementations, the exchange ledger 122 can be configured for executing the currency exchange transactions. For example, the exchange ledger 122 can be used to track changes in currency ownership, manage exchange rates, and record transactions related to the exchange of currencies. Thus, it should be understood that separation of the asset ledger 120 and the exchange ledger 122 can improve security and efficiency. That is, this architecture improves scalability by distributing the load across multiple systems. In some implementations, cross-ledger exchanges or transaction can occur. That is, cross-ledger exchanges can be exchanges that include the transferring of data or value between different blockchains or ledgers. For example, a cross-ledger exchange can be facilitated by cross-ledger protocols or bridge services that use secure data sharing and transaction completion. Additionally, external services or oracles can be used to fetch and verify data (e.g., off-chain) from one ledger to another. For example, an external service can be used by the exchange ledger 122 to validate conditions that affect transactions (e.g., confirming asset performance from the asset ledger 120 for use in the exchange ledger 122).

Additionally, the smart contracts can be generated to manage securitized assets and their conditions. The smart contracts can be broadcast to the ledgers, where they can be stored and executed. When conditions met (e.g., asset reaches a certain performance threshold, such as a distribution date), the smart contract on the asset ledger 120 can trigger a transaction that may affect the exchange ledger 122 (e.g., releasing funds or converting currency as per the latest exchange rates). In some implementations, the asset can be defined and managed entirely within the smart contract. That is, the smart contract can contain the rules and functions for managing the asset and can store the asset's defining data. For example, in tokenized assets, the token representing the asset (such as real estate, bonds, or other financial instruments) is created and exists within the context of the smart contract. In this example, the smart contract may define how the assets can be transferred, the conditions under which they can be exchanged, and any other business logic, such as dividend distribution or performance-related actions. That is, everything can be self-contained within the blockchain environment, and the blockchain block that stores the smart contract can store information about the asset. In some implementations, the smart contract can control or manage the asset. That is, the asset may be represented outside the smart contract, either as a separate entry in the asset ledger 120 or as an external asset not stored directly on the asset ledger 120. For example, the smart contract may contain pointers or references (such as unique identifiers or hashes) to where the asset's data is stored. In this example, the pointer may be to another block within the same blockchain, a different blockchain, or even an off-chain database (e.g., external from the asset ledger 120).

For example, an investor may purchase a securitized asset on the asset ledger 120, which records and manages a variety of securitized debts, such as corporate bonds. This particular asset may be structured to receive payments from multiple obligees in Euro (EUR), but the investor prefers to receive their monthly distribution in US Dollar (USD). Upon the purchase of the securitized asset, the details of this transaction, including the investor's preference for USD distributions, are recorded on the asset ledger 120. The smart contracts stored on this ledger can be programmed to manage the receipt and accounting of monthly payments from the obligees in EUR. In this example, the smart contracts can also include conditions for when and how currency conversion should be triggered based on the predefined distribution schedules. As the EUR payments are collected, they can be recorded by the smart contracts on the asset ledger 120 until a scheduled distribution to the investor. At the point of distribution, the ledger interface system 116 can interface with both the asset ledger 120 and the exchange ledger 122 to initiate the currency conversion process. The ledger interface system 116 can receive a notification from the smart contracts on the asset ledger 120 that a distribution is due. In response, ledger interface system 116 can communicate with the smart contracts on the exchange ledger 122, which are tasked with managing currency exchanges. The exchange ledger 122, utilizing real-time exchange rates provided by external data sources 160, can perform the conversion of the accumulated EUR into USD. This conversion process may be based on the latest available rates to provide the investor with an amount equivalent to the current market value of EUR in USD. Once the EUR has been successfully converted to USD, the exchange system 118 can facilitate the transfer of USD to the wallet system 142 of the investor. External entities that operate the data sources 160 can include financial institutions such as banks, which provide real-time exchange rates and market indices. Additionally, data providers like news agencies and governments can provide (or make available) financial data feeds, including interest rates, commodity prices, and economic indicators. Market exchanges, such as the New York Stock Exchange (NYSE) or London Stock Exchange (LSE), which can provide trading volumes and price data, can be external entities that operate data sources 160.

The wallet system 142 can be structured or configured to securely store the USD funds and update the investor's account balance. For example, the wallet system 142 can provide a record of the transaction, including the amount converted and deposited, and maintain a transaction history for the investor's reference. In this example, every transaction detail (e.g., from the receipt of EUR to the final crediting of USD into the investor's wallet) can be an immutable recorded on the asset ledger 120 and the exchange ledger 122.

The ledger interface system 116 is structured or configured to facilitate communication between the asset smart contract on the asset ledger 120 and the exchange smart contract on the exchange ledger 122. The ledger interface system 116 can interpret and transmit signals between these smart contracts, verify that data relevant to currency exchanges is synchronized and actionable. For example, the ledger interface system 116 can receive notifications from the asset smart contract that a payment in a first currency has been received and is ready to be exchanged according to the investor's currency preference. In some implementations, the asset smart contract can be programmed to manage the securitization and handling of payments associated with a particular asset class stored on the asset ledger 120. The ledger interface system 116 can receive data from the asset smart contract detailing the completion of conditions such as the receipt of a payment or the meeting of a pre-set performance threshold. For example, the asset smart contract may notify the ledger interface system 116 when a monthly payment in euros from European debtors is collected, indicating that these funds should now be exchanged into U.S. dollars. In some implementations, the exchange smart contract can be programmed to execute currency exchanges by interfacing with data sources 160 that provide current exchange rates. The ledger interface system 116 can trigger the exchange smart contract when it receives confirmation from the asset smart contract that a currency exchange needs to be performed. For example, once the ledger interface system 116 verifies that the asset smart contract's conditions have been met, it can instruct the exchange smart contract to convert the received euros into U.S. dollars at the most recent market rate.

In some implementations, the off-chain condition can be one or more market or environmental variables. In some examples, the one or more market and/or environmental variables affect the terms of the smart contract but are not recorded on the blockchain. The ledger interface system 116 can also monitor these off-chain conditions through external data feeds. For example, an off-chain condition may include a spike in the exchange rate between euros and U.S. dollars due to unexpected economic news, prompting the exchange ledger 122 to perform an immediate conversion to lock in favorable rates. In some implementations, an indication can be a signal or data sent by smart contracts to the ledger interface system 116 to communicate the status of a transaction or condition. In some implementations, the indication can include smart contract validation information. That is, the smart contracts of the ledgers can aggregate and verify the off-chain data feeds, which can be packaged as smart contract validation information. For example, the smart contracts can compile timestamps, cryptographic hashes, and source verifications. The smart contract validation information can then be used by the ledger interface system 116 to authenticate and process the transaction. For example, the ledger interface system 116 can cross-check the timestamps and cryptographic hashes to validate data integrity before proceeding. In another example, the system can verify the source of the data to verify it is from a trusted provider. In some implementations, the ledger interface system 116 can analyze these indications to determine one or more execution steps in the transaction process. For example, an indication may include confirmation of payment receipt in euros with a current exchange rate fetched from external data sources. In some implementations, the current exchange rate can be financial data that determines the value exchange between two currencies. The ledger interface system 116 can use the current exchange rate provided by the exchange smart contract to facilitate and finalize the currency conversion process.

For example, an off-chain condition might be a significant economic announcement, such as a change in interest rates by the European Central Bank, causing a spike in the EUR/USD exchange rate. The ledger interface system 116 can continuously monitor financial news feeds and economic indicators. When it detects a news event that causes a rapid increase in the EUR/USD exchange rate, it signals the exchange ledger 122 to perform an immediate conversion of euros to dollars. The ledger interface system 116 fetches the current exchange rate from an external data feed, processes the conversion to lock in the favorable rate, and updates the user's wallet balance accordingly. In another example, another off-chain condition could be a sudden increase in market volatility, indicated by a surge in the Volatility Index (VIX). The ledger interface system 116 can monitor market indices and financial instruments through various external data feeds. Upon detecting a spike in the VIX, which may impact currency stability, the ledger interface system 116 can trigger smart contracts to adjust asset allocations. For example, it may convert holdings from a volatile currency to a more stable one. The ledger interface system 116 processes these changes by updating the exchange ledger 122 and reflecting the new asset allocation in the user's wallet. In yet another example, a regulatory announcement affecting cryptocurrency markets, such as a new law in the U.S. impacting Bitcoin transactions, can serve as an off-chain condition. The ledger interface system 116 can track regulatory news and updates through dedicated legal and financial news feeds. If a regulatory change is detected, the ledger interface system 116 can trigger smart contracts to convert cryptocurrency holdings to fiat currency to avoid potential losses. The ledger interface system 116 can process this by obtaining the latest exchange rates, performing the conversions on the exchange ledger 122, and updating the user's wallet balance to reflect the new holdings. In yet another example, an unexpected geopolitical event, such as a sudden diplomatic conflict or trade embargo, affecting currency values can be an off-chain condition. The ledger interface system 116 can monitor geopolitical news sources for such events. If a geopolitical event causes a sharp decline in the value of a particular currency, the ledger interface system 116 can trigger an automatic conversion to a more stable currency. For example, a sharp drop in the GBP due to Brexit developments could prompt the ledger interface system 116 to convert GBP holdings to USD or EUR. The ledger interface system 116 processes this by checking real-time exchange rates, executing the conversion on the exchange ledger 122, and updating the user's wallet to reflect the changes.

The exchange computing system 118 (shown as “exchange system 118”) is structured or configured to execute or perform currency conversions based on transactions initiated by smart contracts across linked ledgers. The exchange system 118 can process these conversions on the exchange ledger 122, where it uses smart contracts to analyze current market data and execute trades according to predefined rules within the smart contracts. For example, when a bond issued in USD needs or is desired to be paid out in JPY on a scheduled dividend date, the exchange system 118 can automatically calculate the exchange based on the current USD to JPY rate provided by smart contracts (or directly from external data sources) and initiate the currency conversion process on the exchange ledger 122. In some implementations, the indication by the one or more smart contracts can include the detection of a distribution or dividend date, signaling that a currency conversion should be processed to meet the payment obligations. The exchange system 118 can interpret these indications to activate the currency conversion process on the exchange ledger 122, ensuring that transactions adhere to the terms specified in the smart contracts and are executed in time for the distribution. For example, if a smart contract stipulates that funds should be converted for a dividend payout on February 15, the exchange system 118 can process this conversion on the exchange ledger 122 once scheduled date has been met. In some implementations, an exchange conversion includes the conversion of funds from one currency to another, specifically executed on the exchange ledger 122 as directed by the exchange system 118 in response to smart contract triggers such as distribution dates. The exchange system 118 can facilitate and executes these conversions by interfacing with currency markets and using the latest exchange rates to determine the amount of the second currency to be disbursed. For example, if an investor in a U.S.-based bond desires a payout in euros on the dividend date, the exchange system 118 will convert the necessary dollar amount into euros at the current exchange rate at the time of transaction execution on the exchange ledger 122. In some embodiments, the exchange computing system 118 can include one or more processing circuits, including processor(s) and memory. The memory may have instructions stored thereon that, when executed by processor(s), cause the one or more processing circuits to perform the various operations described herein. The operations described herein may be implemented using software, hardware, or a combination thereof. The processor(s) may include a microprocessor, ASIC, FPGA, etc., or combinations thereof. In many implementations, processor(s) may be a multi-core processor or an array of processors. Memory may include, but is not limited to, electronic, optical, magnetic, or any other storage devices capable of providing processor(s) with program instructions. The instructions may include code from any suitable computer programming language.

In some implementations, updating a plurality of ledger balances can include adjusting the records on multiple distributed ledgers to reflect the new states following a currency conversion (e.g., updating the exchange ledger 122 to reflect these changes). The exchange system 118 can synchronize these updates across different ledgers to maintain accuracy and consistency in financial records (e.g., after executing conversions on scheduled distribution or dividend dates). For example, after converting USD to JPY for a bond payout, the exchange system 118 can update the ledger balances on the exchange ledger 122 to show the deduction in USD and the addition in JPY. In some implementations, a pending exchange may be a temporary state of a transaction while it is being processed but has not yet been finalized. For example, an exchange may be pending during the execution of conversions on the exchange ledger 122 on scheduled dividend dates. The exchange system 118 can lock the funds in the exchange to prevent them from being used in other transactions until the exchange is completed. For example, when a currency conversion is initiated on a dividend payout date, the exchange system 118 can temporarily lock the exchange funds on the exchange ledger 122 to secure the transaction and prevent double spending until the conversion is fully processed and verified. In some implementations, temporarily locking exchange funds can be implemented by the exchange system 118 to ensure that once a currency conversion transaction is initiated on the exchange ledger 122, the funds are reserved for that transaction until it is completed. For example, when multiple transactions are being processed simultaneously on a dividend date, temporarily locking the funds can isolate each transaction until completion.

The exchange system 118 is structured or configured to perform the transfer of currency (e.g., resources) to the wallets (e.g., wallet system 142) of receiving parties. The exchange system 118 can ensure that all or a predefined amount of currency transfers are securely processed and adhere or substantially adhere to predefined transaction protocols. For example, the exchange system 118 may transfer US dollars converted from euros to an investor's digital wallet after a successful currency exchange on the exchange ledger 122. In some implementations, a second currency can be the currency that has been converted from a first currency and is to be transferred to the receiving party. The exchange system 118 can perform the transfer of this second currency by initiating and verifying transfer commands on the blockchain network (e.g., exchange ledger 122). For example, if euros are converted to Japanese yen, the yen becomes the second currency that the exchange system 118 will transfer to the designated recipient's wallet (e.g., wallet system 142). In some implementations, the wallet system 142 of the receiving party can be a digital destination for the second currency being transferred by the exchange system 118. The exchange system 118 interfaces with various wallet systems, like wallet system 142 or the user computing system 140, to deliver the converted currency securely. For example, after converting a bond's payout from USD to EUR, the exchange system 118 may deposit the euros into the investor's wallet system 142, which is registered and verified on the exchange ledger 122.

In some implementations, the exchange system 118 can generate identifiers and/or timestamps to provide precise timing and accuracy of transactions across different time zones and financial markets. For example, exchange system 118 can generate and assign unique identifiers to each transaction, which can be used to track and verify the status of currency exchanges on the exchange ledger 122. Timestamps, synchronized with universal coordinated time (UTC), can be embedded in each transaction record to establish the exact moment of transaction initiation and completion. Furthermore, the use of timestamps can be important in transactions involving participants across multiple jurisdictions, where local time discrepancies might otherwise lead to confusion or disputes about the timing of transactions. For example, if a transaction needs to be executed at the close of the business day in Tokyo, the exchange system 118 can verify that the transaction is timestamped accurately to reflect Tokyo's local time, irrespective of where the other transaction parties are located.

In some implementations, transferring can include the process by which the exchange system 118 sends the second currency to a recipient's wallet following a currency conversion. The exchange system 118 can comply with some or all or some security and protocol requirements set forth by the blockchain network during this process. For example, transferring may include the exchange system 118 sending a blockchain transaction on the exchange ledger 122 to move yen from a conversion account to the investor's wallet after the initial currency exchange. In some implementations, the exchange system 118 can validate a wallet credential by verifying the identity and access permissions of the wallet receiving the second currency. The exchange system 118 can authenticate wallet credentials to prevent unauthorized access and confirm that the currency is sent to the correct and intended wallet. For example, before transferring the second currency, the exchange system 118 may require authentication of the wallet's public key (e.g., of wallet system 142) and associated security features to confirm that the wallet belongs to the receiving party. In some implementations, executing a confirmed ledger exchange can be the finalization of a currency transaction on a blockchain, such as the exchange ledger 122. The exchange system 118 can manage this process to securely and immutably record the transaction on the ledger system 122. For example, the exchange system 118 can finalize the transfer of converted currency to the investor's wallet system 142 by recording the transaction as a confirmed block on the exchange ledger 122. In some implementations, a pending exchange can be the status of a currency conversion transaction that is not yet finalized on the exchange ledger 122. The exchange system 118 can monitor and update the status of pending exchanges to manage the workflow of currency transfers. For example, a pending exchange may exist when the converted currency is ready to be transferred but is waiting for final validation and confirmation processes to complete on the exchange ledger 122 before it is moved to the receiving party's wallet (e.g., wallet system 142).

The user computing system 140 can be a mobile device, desktop computer, tablet, smart device, or other electronic device the can execute and store the wallet system 142. The user computing system 140 may include processing units, memory storage, input/output interfaces, and network connectivity components to interact with the wallet system 142 and other systems described herein (e.g., over network 130). The user computing system 140 can execute software applications, perform data processing tasks, and establish secure connections to blockchain networks for real-time transaction updates. In some implementations, the wallet system 142 of the user computing system 140 can be a digital wallet for investors to manage and receive distributions from securitized assets. It can be integrated within the user computing system 140, providing an interface for viewing investment returns, managing asset portfolios, and receiving payments. The wallet system 142 can be structured to include security features such as encryption and multi-factor authentication to protect investment transactions and data. In some implementations, the wallet system 142 can communicate with blockchain networks, such as exchange ledgers 122 and/or 124, providing real-time synchronization of transaction data and updates of wallet balances as distributions occur. The wallet system 142 can facilitate the receipt of currency distributions automatically execute through smart contracts from investments. For example, if an investor holds bonds that distribute dividends in multiple currencies, the wallet system 142 will receive these payments directly, reflecting the updated balance immediately after each distribution.

Smart contracts generated by the contract generation system 114 and deployed on exchange ledger 122 can similarly be deployed on exchange ledger 124 to provide cross-ledger interactions. The smart contracts on exchange ledger 124 can facilitate interactions with both exchange ledger 122 and asset ledger 120. For example, a smart contract on exchange ledger 124 may execute currency exchanges directly with exchange ledger 122, facilitating transactions such as currency conversion from GBP to JPY. Additionally, a smart contract on exchange ledger 124 may access asset information stored on asset ledger 120, such as dividend amounts, interest rates, current currency of securitized assets, and asset types.

In some implementations, the exchange ledger 124 can operate in coordination with exchange ledger 122, which may represent different regional exchange networks. For example, the regional exchange network may be a UK commercial exchange network and a Japanese exchange network. The exchange ledger 124 can utilize one or more algorithms to handle real-time currency conversions and transfers across the networks. In some implementations, the exchange ledger 124 can include regulatory compliance tools for managing international currency transactions and adhering to various national regulations. The exchange ledger 124 can interface with the exchange ledger 122 to facilitate cross-border currency exchanges and improve liquidity management. The connectivity between exchange ledger 122 and exchange ledger 124 can provide efficient and compliant transaction handling across borders. For example, if an investor needs to convert dividend payments received in Japanese yen on exchange ledger 124 to British pounds on exchange ledger 122, the exchange system 118 can manage this conversion and transfer, confirming that the funds are available in the investor's preferred currency on their wallet system 142.

Generally, the communications between exchange ledger 122 (e.g., UK commercial exchange network) and exchange ledger 124 (Japanese exchange network or USD exchange network) with wallet system 142 can facilitate the management of the financial transactions (e.g., of global investors). When dividends or distributions are issued from assets held in one country (e.g., on asset ledger 120) but need to be received in another, the exchange system 118 can facilitate the currency conversions and transfers. For example, if an investor based in the UK receives dividends in yen from investments managed on the Japanese exchange network (exchange ledger 124), these are converted to pounds through the UK commercial exchange network (exchange ledger 122) before being deposited into the investor's wallet system 142. Another example is when an investor wishes to reinvest dividends received in one currency into assets denominated in another currency; the necessary conversions are handled seamlessly between the exchange ledgers before the funds are moved to or from the wallet system 142.

Generally, the utilization of multiple exchange ledgers, such as exchange ledger 122 and exchange ledger 124, can be used in a globalized financial market where investors engage with assets across different currencies and regulatory environments. Each ledger can be implemented and deployed for specific regional market conditions, facilitating solutions for currency conversion, liquidity management, and regulatory compliance. The multiple ledgers provide an improved infrastructure that enhances exchange processing speed and reliability while reducing the technical problems associated with reliance on a single network. For example, the interaction between the UK commercial exchange network (e.g., exchange ledger 122) and the Japanese exchange network (e.g., exchange ledger 124) can provide efficient management of currency risks and regulatory compliance, ensuring that investors can securely and efficiently receive and reinvest dividends across markets. Additionally, the multiple exchange ledgers also spreads transaction loads and minimizes potential technical problems, which can be important during periods of high market volatility or regulatory changes.

For example, to perform a currency exchange between the exchange ledger 122 and exchange ledger 124, the process can begin when a smart contract on one of the exchange ledgers detects a condition that necessitates a currency exchange. This condition might be a predefined distribution schedule, a predefined exchange rate threshold, a scheduled transaction time, or a request initiated by a user or another smart contract, for example, residing on asset ledger 120, signaling the need for currency conversion. Upon activation, the smart contract can execute a verification process to validate the transaction conditions against its programmed logic and the current ledger state. This may include confirming the availability of funds, the authenticity of the transaction request, and compliance with regulatory standards. Further in this example and following verification, the smart contract can retrieve the current exchange rate from a trusted oracle or a real-time data feed integrated within the ledger system (e.g., data sources 160). This rate may be periodically updated directly on the ledger or fetched from an externally approved data source, according to the ledger's governance protocols. Using the retrieved rate, the smart contract can calculate the amount of currency to be exchanged and executes the transaction by creating ledger entries that debit the source currency and credit the equivalent amount in the target currency. In this example, if the transaction includes moving funds between different ledgers, such as from exchange ledger 124 to exchange ledger 122, the smart contract initiates a cross-ledger transaction using cryptographic protocols (e.g., atomic swaps or through a trusted intermediary system designed to interface with multiple ledgers). The transaction can be considered settled once the changes in balances are confirmed and recorded on both ledgers involved. Reconciliation processes can be employed to verify that all or some debits and credits across the ledgers are consistent, maintaining transaction integrity. For example, a consensus mechanism may be executed where all or some participating nodes across the ledgers agree to the transaction. Still in this example, upon successful execution and settlement, the smart contract can update the transaction status and notifies the relevant parties, such as the initiating user or system. The smart contract(s) can also logs the transaction details for reporting, auditing, and compliance. Throughout this example, various security measures including encryption, multi-signature validations, and continuous monitoring for anomalies can be performed to protect the assets and the integrity of the transaction.

Referring to FIG. 1B, a block diagram of another example system is shown, according to some embodiments. FIG. 1B illustrates configurations where features and functionality similar to FIG. 1A are implemented, with the distinction that asset and exchange ledgers are integrated into single ledger systems, depicted as asset and exchange ledger 150 and asset and exchange ledger 152. This configuration merges asset management and currency exchange functionalities within the same distributed ledger framework, such that smart contracts deployed on these ledgers can access and manipulate both asset and currency data within the same transactional framework. That is, this configuration integrates asset management and currency exchange functionalities within the same distributed ledger framework, facilitating access and manipulation of both asset and currency data by smart contracts deployed on these ledgers.

In the combined ledger implementation, smart contracts can be structured or configured to perform functions such as automatic conversion of dividends from assets denominated in one currency to another based on predefined criteria within the asset and exchange ledger 150. For example, a smart contract on the asset and exchange ledger 150 may detect a dividend distribution event and execute a currency conversion using real-time exchange rates stored or accessible within the asset and exchange ledger 150. In this example, the transaction details, including the conversion rate applied and the resultant currency amount, can be recorded on the asset and exchange ledger 150. In some implementations, smart contracts on the combined asset/exchange ledgers can be programmed to execute asset-related transactions and currency exchanges without interfacing between separate systems (e.g., as described in FIG. 1A). For example, a smart contract can automate the conversion of dividends from a securitized asset denominated in one currency to another currency based on predefined investor preferences.

In some implementations, communications between integrated ledgers, such as asset and exchange ledger 150 and asset and exchange ledger 152, are configured to support data transfers and transaction validations. The unified ledger structure provides improved processing of validations and reconciliations for different currency transactions and asset management activities. For example, a cross-ledger transaction initiated on asset and exchange ledger 150, related to the transfer of funds from a bond to a different currency held on asset and exchange ledger 152, may be processed through the integrated system. In configurations employing multiple integrated ledgers like asset and exchange ledger 150 and asset and exchange ledger 152, the ledgers can execute under specific operational parameters. That is, the configuration can support currency and asset exchanges and provide compliance and asset management strategies appropriate for various market conditions. Although the disclosure herein references one or two integrated ledgers, the architecture can be scalable and can support numerous such ledgers depending on the requirements and complexity of the operations.

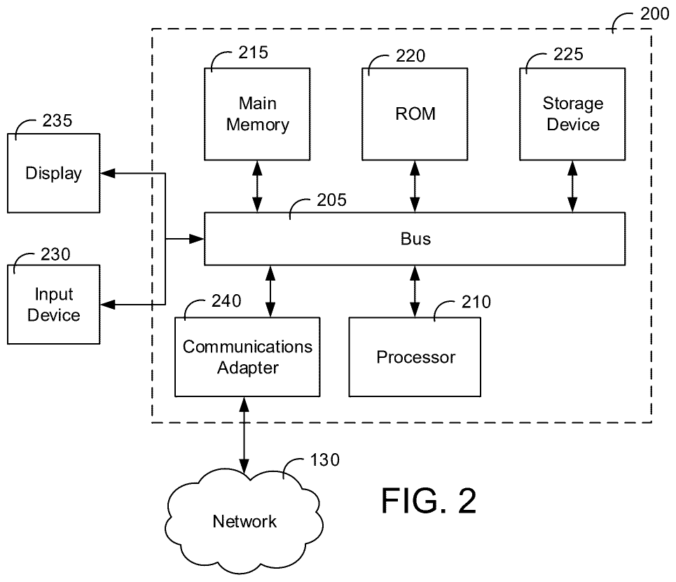

Referring now to FIG. 2, a depiction of a computer system 200 is shown. The computer system 200 that can be used, for example, to implement a computing environment of FIG. 1A or 1B, the analysis system 110, asset ledger 120, exchange ledger 122, exchange ledger 124, user computing system 140, asset and exchange ledger 150, asset and exchange ledger 152, and data sources 160, and/or various other example systems described in the present disclosure. The computing system 200 includes a bus 205 or other communication component for communicating information and a processor 210 coupled to the bus 205 for processing information. The computing system 200 also includes main memory 215, such as a random-access memory (RAM) or other dynamic storage device, coupled to the bus 205 for storing information, and instructions to be executed by the processor 210. Main memory 215 can also be used for storing position information, temporary variables, or other intermediate information during execution of instructions by the processor 210. The computing system 200 may further include a read only memory (ROM) 220 or other static storage device coupled to the bus 205 for storing static information and instructions for the processor 210. A storage device 225, such as a solid-state device, magnetic disk or optical disk, is coupled to the bus 205 for persistently storing information and instructions.

The computing system 200 may be coupled via the bus 205 to a display 235, such as a liquid crystal display, or active matrix display, for displaying information to a user. An input device 230, such as a keyboard including alphanumeric and other keys, may be coupled to the bus 205 for communicating information, and command selections to the processor 210. In another arrangement, the input device 230 has a touch screen display 235. The input device 230 can include any type of biometric sensor, a cursor control, such as a mouse, a trackball, or cursor direction keys, for communicating direction information and command selections to the processor 210 and for controlling cursor movement on the display 235.

In some arrangements, the computing system 200 may include a communications adapter 240, such as a networking adapter. Communications adapter 240 may be coupled to bus 205 and may be configured to provide communications with a computing or communications network 245 (similar features and functionality as network 103) and/or other computing systems. In various illustrative arrangements, any type of networking configuration may be achieved using communications adapter 240, such as wired (e.g., via Ethernet), wireless (e.g., via Wi-Fi, Bluetooth), satellite (e.g., via GPS) pre-configured, ad-hoc, LAN, WAN.

According to various arrangements, the processes that effectuate illustrative arrangements that are described herein can be achieved by the computing system 200 in response to the processor 210 executing an arrangement of instructions contained in main memory 215. Such instructions can be read into main memory 215 from another computer-readable medium, such as the storage device 225. Execution of the arrangement of instructions contained in main memory 215 causes the computing system 200 to perform the illustrative processes described herein. One or more processors in a multi-processing arrangement may also be employed to execute the instructions contained in main memory 215. In alternative arrangements, hard-wired circuitry may be used in place of or in combination with software instructions to implement illustrative arrangements. Thus, arrangements are not limited to any specific combination of hardware circuitry and software.

That is, although an example processing system has been described in FIG. 2, arrangements of the subject matter and the functional operations described in this specification can be carried out using other types of digital electronic circuitry, or in computer software (e.g., application, blockchain, distributed ledger technology) embodied on a tangible medium, firmware, or hardware, including the structures disclosed in this specification and their structural equivalents, or in combinations of one or more of them. Arrangements of the subject matter described in this specification can be implemented as one or more computer programs, e.g., one or more subsystems of computer program instructions, encoded on one or more computer storage medium for execution by, or to control the operation of, data processing apparatus. Alternatively, or in addition, the program instructions can be encoded on an artificially generated propagated signal, e.g., a machine generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

Although shown in the arrangements of FIG. 2 as singular, stand-alone devices, one of ordinary skill in the art will appreciate that, in some arrangements, the computing system 200 may include virtualized systems and/or system resources. For example, in some arrangements, the computing system 200 may be a virtual switch, virtual router, virtual host, virtual server. In various arrangements, computing system 200 may share physical storage, hardware, and other resources with other virtual machines. In some arrangements, virtual resources of the network may include cloud computing resources such that a virtual resource may rely on distributed processing across more than one physical processor, distributed memory, etc.

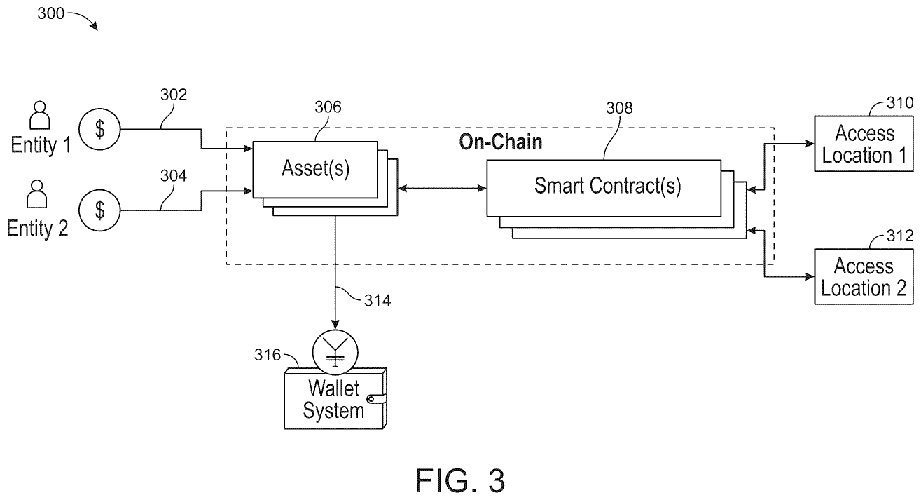

Referring now to FIG. 3, depicting an example exchange architecture 300, according to some implementations. As shown, after the assets 306 have been securitized, the analysis system 110 can provide the ledgers (e.g., on-chain) with income or payment made by the entities corresponding to the securitized assets. For example, payment 302 may be made in USD by Entity 1 for securitized asset 306. In another example, payment 304 may be made in USD by Entity 2 for securitized asset 306. In this example, the securitized asset 306 may be automobile loans of United States (US) consumers. As shown, the US consumer may provide payments in USD but the investor or receiving party with a right to the performance of the securitized asset 306 may be a citizen of Japan and/or the United Kingdom. That is, the investors may desire payment in other types of currency from different international currencies depending on the exchange rate. Accordingly, smart contracts can be implemented for the securitized asset 306 to determine exchange rates, identify predefined distribution schedule, determine desired currency outputs, automate currency conversions, and facilitate compliance with international financial regulations such that payments are disbursed accurately and on time. In some implementations, the assets 306 and smart contracts 308 can be on-chain. That is, the assets 306 and smart contracts 308 can be stored in the same ledger system (e.g., asset and exchange ledgers 150 and/or 152) or different ledger systems (e.g., asset ledger 120, exchange ledger 122, and/or exchange ledger 124). For example, the asset ledger 120 might store the asset details while the exchange ledger 122 handles transactions. In another example, exchange ledger 124 may be used for international transactions.

In some implementations, the smart contracts 308 can interface with access locations. In some implementations, the access locations can be interfaced using a plurality of off-chain data feeds accessible for monitoring by the one or more smart contracts 308. For example, smart contract 308 may interface with access location 310 to obtain asset information such as ownership records, disbursement schedules, desires output currency, and payment histories. In this example, the smart contracts 308 may use the asset information to validate and enforce payment schedules. In another example, smart contract 308 may interface with access location 312 to obtain exchanges rates between a first currency (e.g., USD) and a second currency (e.g., Japanese Yen). That is, the access locations 310 and 312 can serve as verification points for the authenticity and accuracy of data. In some implementations, a disbursement, dividend, or return can be made to wallet system 316 (having similar features and functionalities as wallet system 142 of FIGS. 1A and 1B). For example, payment 314 may be in Japanese Yen following a predefined distribution schedule, satisfaction of a desired exchange rate, or meeting contractual obligations. For example, the predefined distribution schedule may be quarterly or annually based on the investment agreement. In another example, the satisfaction of a desired exchange rate may be when the USD to JPY rate falls below a certain threshold. In yet another example, the funds are converted and disbursed upon receiving confirmation from both involved ledgers. In some implementations, payment 314 to wallet system 316 can occur on-chain, such that the ledger entries can be updated simultaneously across all or some participating nodes. For example, the wallet system 316 may be integrated directly into the ledger architecture, such that the wallet system 316 can function as a storage unit and a transaction verification node within the blockchain network. For example, each transaction with the wallet system 316 can trigger an update that is propagated to all or some nodes, maintaining consistent and up-to-date ledger states across the distributed system.

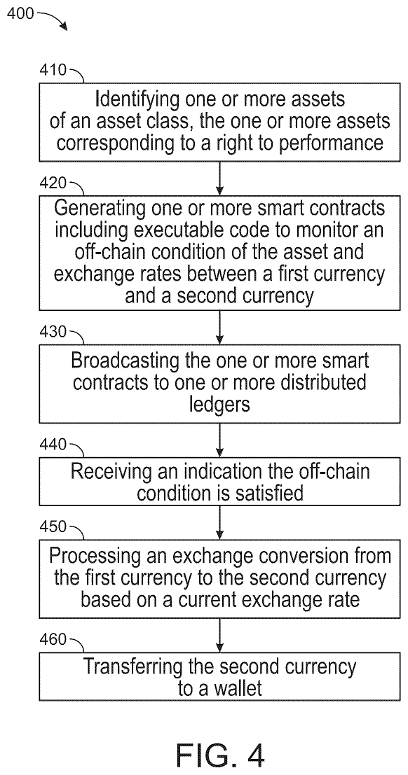

Referring now to FIG. 4, depicting a method to manage currency exchanges, according to some implementations. At least one of the example system of FIGS. 1A and 1B, or the example exchange architecture 300, can perform method 400 according to present implementations.

In broad overview of method 400, at block 410, the one or more processors (e.g., analysis system 110, specifically the asset identification system 112) can identify one or more assets of an asset class, the one or more assets corresponding to a right to performance. At block 420, the one or more processors (e.g., contract generation system 114) can generate one or more smart contracts including executable code to monitor an off-chain condition of the asset and exchange rates between a first currency and a second currency. At block 430, the one or more processors (e.g., ledger interface system 116) can broadcast the one or more smart contracts to one or more distributed ledgers. At block 440, the one or more processors (e.g., ledger interface system 116) can receive an indication the off-chain condition is satisfied. At block 450, the one or more processors (e.g., exchange system 118) can process an exchange conversion from the first currency to the second currency based on a current exchange rate. At block 460, the one or more processors (e.g., exchange system 118) can transfer the second currency to a wallet. Additional, fewer, or different operations may be performed depending on the particular implementation. In some embodiments, some, or all operations of method 400 may be performed by one or more processors executing on one or more computing devices, systems, or servers. In various embodiments, each operation may be re-ordered, added, removed, or repeated. Additionally, some or all of the operations performed by the blocks may be removed or added based on the type of token received (e.g., fungible, non-fungible, or partially fungible).

In broad overview, method 400 relates to instant settlement of funds and, particularly, foreign exchange settlements. By tracking foreign currencies to make them become more fungible, instant settlement of foreign exchanges may be possible. This may also be referred to as asset interoperability. Using distributed ledger technology, method 400 can include storing and moving data instantaneously (e.g., in foreign currency exchanges). This can facilitate real-time or near real-time settlement. Additionally, method 400 can define conditions for the grouped currencies and securitize that group. In some implementations, method 400 can include the transfer of value on a ledger which can replace SWIFT (e.g., that is, since there is no money in SWIFT, just messages). In some implementations, method 400 can also include a real-time reconciliation aspect as part of the foreign currency exchange. Additionally, method 400 can create transaction mechanisms for clients that meet conditions on multiple chains. In some implementations, a smart contract or other mechanism may be used to reconcile it with other ledgers.

At block 410, the processors (e.g., asset identification system 112) can identify one or more assets of an asset class corresponding to an asset grouping framework. In some implementations, the one or more assets can correspond to a right to performance in a first currency from one or more entities. In some implementations, the processors can securitize multiple currencies under defined conditions, providing exchanges on the ledgers when these predefined conditions, such as exchange rates or distribution schedules, are met. In some implementations, the one or more assets can include one or more distribution parameters corresponding to a distribution in a second currency to a receiving party based on a predefined distribution schedule. In some implementations, identifying the one or more assets can include securitizing, by the one or more processing circuits, the one or more assets. In some implementations, identifying the one or more assets can also include determining a projected distribution at the predefined distribution schedule of the one or more assets, wherein the projected distribution is stored in the off-chain condition on the one or more distributed ledgers, wherein the projected distribution is in the second currency. In some implementations, identifying the one or more assets can also include transmitting the projected distribution at the predefined distribution schedule in the second currency to a receiving party computing system. In some implementations, identifying the one or more assets can also include receiving a signed agreement corresponding to the projected distribution and the predefined distribution schedule in the second currency.

In some implementations, the processors can be devices that execute identification processes. For example, processors can identify one or more assets that are categorized into an asset class corresponding to an asset grouping framework. In some implementations, assets can correspond to rights to performance based on contractual obligations. For example, these assets can grant the holder a right to receive returns in a first currency from one or more entities. In some implementations, assets can include distribution parameters dictating the specifics of currency distribution to a receiving party as per a predefined schedule. In some implementations, the asset class can be as a classification framework for grouping similar types of investments. For example, an asset class may include various forms of securities like bonds or stocks that share similar market behaviors. In some implementations, an asset grouping framework can be a framework used to organize assets based on specific criteria. For example, this framework may be based on risk profiles, expected returns, types of securitized assets (e.g., bonds, mortgages, etc.) or compliance with regulatory requirements. In some implementations, distribution parameters can be defined criteria that manage the flow of assets. For example, the parameters may specify the conditions under which income or the assets are distributed, such as timing and currency type. In some implementations, the predefined distribution schedule can be a timeline or set time periods that identify when distributions should occur. For example, this schedule may be aligned with fiscal quarters or specific dates significant to the asset holders. In some implementations, the receiving party can be an entity designated to receive assets or currency as outlined in distribution parameters. For example, the receiving party may be investors or stakeholders who are scheduled to receive dividends or interest payments. In some implementations, the first currency can be at least one of a first type of fiat currency, digital currency, utility token, or cryptocurrency and the second currency can be at least one of a second type of fiat currency, digital currency, utility token, or cryptocurrency. For example, the first currency may be the US dollar. In another example, the first currency might be Bitcoin. In yet another example, the first currency may be Ethereum's Ether. In yet another example, the first currency may also be Ripple's XRP. For example, the second currency may be the Euro. In another example, the second currency might be Litecoin. In yet another example, the second currency may be Binance Coin. In yet another example, the second currency may also be Stellar's Lumens.

In some implementations, the processors can determine the one or more distribution parameters of the receiving party based on inputting historical exchange data and a receiving party profile into a trained artificial intelligence (AI) model and receiving the one or more distribution parameters as an output. In some implementations, the distribution parameters can define the conditions under which financial distributions are made. For example, distribution parameters may specify the amount, currency, and timing of payments to a receiving party. In some implementations, the receiving party can be the beneficiary or entity entitled to receive assets or funds as defined by the distribution parameters. For example, the receiving party may be an investor receiving dividends or an account holder receiving payments. In some implementations, historical exchange data can provide a record of past currency exchange rates and market behaviors. For example, this data can be used to forecast future rates and trends for better financial planning and risk assessment. In some implementations, the receiving party profile can include demographic and financial information about the recipient of funds or assets. For example, the profile may include data on past transactions, preferred currencies, and risk tolerance which helps in customizing the distribution parameters. In some implementations, the AI model can be an algorithm trained to perform tasks. For example, an AI model can analyze large sets of data to identify patterns and make predictions about future outcomes. In some implementations, the processors can determine the settings or values for specific operations based on predefined criteria. For example, determining the distribution parameters can include assessing the receiving party's needs and the contextual data provided by historical exchange rates. For example, inputting historical exchange data and a receiving party profile into an AI model can facilitate the processor to integrate and interpret these inputs for predictive analytics. In another example, receiving the output from an AI model can provide the processors the data to finalize the distribution parameters based on the analyzed data.

In some implementations, identifying includes the processors determining specific characteristics or categories of assets. For example, identifying may include the analyzing financial instruments to classify them according to type and risk. In some implementations, securitizing includes converting traditional asset forms into tradeable securities. For example, securitizing may be performed by the processors to improve the liquidity of real estate or loans by turning them into bonds or other financial instruments. Furthermore, the processors may securitize multiple currencies and define conditions for these grouped currencies, using DLT to provide immediate data movement and settlement. In some implementations, determining the projected distribution includes calculating the expected outputs or returns from an asset. For example, determining may be used by processors to forecast future cash flows or dividends based on current economic conditions and past performance. In some implementations, transmitting the projected distribution at the predefined distribution schedule or specific exchange rate includes sending data or funds to designated recipients. For example, transmitting may be the process by which processors send digital notifications or currency distributions to investors' computing systems. In some implementations, receiving signed agreement includes accepting data or agreements that are transmitted electronically. For example, receiving may include processors collecting signed agreements from investors confirming their understanding and acceptance of the distribution terms.

At block 420, the processors (e.g., contract generation system 114) can generate one or more smart contracts including executable code to monitor an off-chain condition of the one or more assets and exchanges rates between the first currency and the second currency. That is, the executable code provides real-time tracking and response to changes in market conditions or asset statuses that are not directly recorded on the blockchain. For example, this code can trigger specific contractual actions when exchange rates reach a threshold that favors asset conversion or settlement. In some implementations, the processors can tokenize the financial agreements to provide immutability and deploy smart contracts across linked ledgers to facilitate real-time reconciliation and prevent arbitrage by monitoring transaction timings. For example, the processor can tokenize agreements between transaction parties to provide immutability throughout the asset's lifecycle. In some implementations, the off-chain condition correspond to a plurality of access locations to a plurality of off-chain data feeds accessible for monitoring by the one or more smart contracts. For example, the processors can determine a first access location of the plurality of access locations of a first data feed of the plurality of off-chain data feeds corresponding to the one or more assets. In this example, the first data feed may provide real-time financial performance data of securitized assets. In some implementations, the processors can determine a second access location of the plurality of access locations of a second data feed of the plurality of off-chain data feeds corresponding to the exchanges rates between the first currency and the second currency. In this example, the second data feed may provide live foreign exchange rates. In some implementations, the access locations can serve as integration points for extracting external data.

In some implementations, smart contracts can be self-executing contracts with the terms of the agreement written into code. For example, the contracts can automatically enforce their conditions based on changes detected in the associated digital or physical assets. In some implementations, the executable code can be programming instructions that carry out specific functions within a smart contract. For example, the code can continuously monitor exchange rates and asset conditions, initiating predefined actions when certain criteria are met. In some implementations, an off-chain condition can be to any state or event that is not recorded on the blockchain but affects the execution of a smart contract. For example, this may include external financial indicators or regulatory updates that impact asset valuations or trading strategies. In some implementations, assets can be digital or physical properties that have economic value and may be involved in generating smart contracts. For example, these assets may range from securities to commodities, whose status or performance should have constant monitoring. In some implementations, exchange rates represent the value of one currency in terms of another. For example, smart contracts may use real-time exchange rates to execute trades or settlements automatically when favorable conditions are detected. In some implementations, the first and second currencies can be the different denominations of money involved in a transaction or financial contract. For example, a smart contract may manage the conversion from the first currency (e.g., USD) to the second currency (e.g., EUR) as part of its operational logic. In some implementations, the processors can generate digital constructs or outputs based on given inputs or programming directives. For example, generating smart contracts includes creating secure, deployable contracts that can autonomously perform actions based on predefined conditions. In some implementations, to monitor can include continuously accessing or tracking the state of a variable or process. For example, smart contracts can monitor off-chain conditions and currency exchange rates to perform timely exchanges that align with, for example a distributed schedule or exchange rate of the contract parties.

In some implementations, a first smart contract of the one or more smart contracts can monitor the one or more assets on a first ledger of the one or more distributed ledgers. For example, this contract may automate asset management processes such as dividend distributions based on predefined conditions. In some implementations, a second smart contract of the one more ore smart contract can monitor the exchange rates on a second ledger of the one or more distributed ledgers. For example, this contract may enforce exchange rate locks or trigger currency exchanges at optimal rates. In some implementations, the executable code can be compatible with the first ledger and the second ledger. For example, the code may be configured to provide interoperability and execution across different blockchain technologies. As shown, separate ledgers may be used that facilitate handling of distinct activities.

In some implementations, a first smart contract of the one or more smart contracts can monitor the one or more assets on a first ledger of the one or more distributed ledgers. For example, the monitoring may be facilitating compliance with regulatory requirements for asset transactions. In some implementations, a second smart contract of the one more smart contracts can monitor the exchange rates on the first ledger of the one or more distributed ledgers. For example, it can synchronize exchange rate data with asset values. In some implementations, wherein the executable code is compatible with the first ledger. As shown, the same ledgers may be used that consolidate data handling and reduce operational complexity. In some implementations, generating the one or more smart contracts further include generating a future contract for a future exchange rate at the predefined distribution schedule. That is, the future contract can lock the future exchange rate for the exchange conversion (e.g., the current exchange rate can be the future exchange rate of the future contract). For example, the future contract may provide predictability for investors by locking in favorable exchange rates ahead of actual currency conversion. In another example, it may provide protection associated with currency fluctuations during the payout period.

At block 430, the processors (e.g., ledger interface system 116) can broadcast the one or more smart contracts to one or more distributed ledgers. The distributed ledgers can be blockchains. Additionally, an asset smart contract can be broadcast to an asset ledger and an exchange smart contract can be broadcast to an exchange ledger. That is, smart contracts can be broadcast across interconnected ledgers, designed to operate as if they were a single ledger, improving interoperability and preventing double spending through synchronized transaction validation. For example, the asset smart contract manages asset-related transactions while the exchange smart contract handles currency conversions and exchange rate adjustments. In another example, the asset smart contract may automate the management of asset sales or interest payments while the exchange smart contract may handle the implementation of currency conversion strategies. In some implementations, broadcasting includes propagating the one or more smart contracts to a plurality of network nodes through a consensus mechanism. For example, this propagation distributes the contract data to some or all nodes for review and agreement before acceptance. That is, propagating can include the transmission of contract details across the network to facilitate simultaneous data verification by some or all nodes. In some implementations, broadcasting can include signing and verifying the one or more smart contracts before storing the one or more smart contracts on the one or more distributed ledgers. That is, this process authenticates the source and confirms the integrity of the smart contracts to maintain blockchain security. For example, cryptographic signatures may be applied to the contracts to validate their origin and prevent unauthorized modifications.

At block 440, the processors (e.g., ledger interface system 116) can receive, from the one or more smart contracts, an indication the off-chain condition is satisfied. In some implementations, the indication includes a current exchange rate between the first currency and the second currency. For example, an asset smart contract of the asset ledger can trigger the receipt of the current exchange rate when specific market thresholds are met. In some implementations, the indication can further include smart contract validation information corresponding to at least one timestamp and at least one source verification of the plurality of off-chain data feeds. For example, the timestamp can confirm the exact moment the exchange rate data was retrieved. In another example, the source verification can validate the authenticity of the data by confirming it was obtained from a trusted financial institution or market data provider. That is, the smart contract validation information can verify that the data used for executing financial transactions is both current and credible. Additionally, an exchange smart contract of the exchange ledger may provide updates on currency fluctuations that impact contractual obligations. That is, the receival step can include receiving multiple data packages from various market data feeds integrated with the ledger systems. In some implementations, the asset and exchange smart contract can be on the same ledgers to streamline data synchronization. That is, merging the functionality of asset and currency management into a unified ledger architecture reduces latency and improves data integrity. For example, this integration provides real-time updates and adjustments to asset values and exchange rates directly within the same digital framework.

In some implementations, smart contract validation information can include timestamps, cryptographic hashes, and/or source verifications of the off-chain data feeds. Timestamps can be used to verify that the data is timely, indicating the time the data was retrieved or updated. Cryptographic hashes can be used to provide a fingerprint for the data, facilitating verification of data integrity and verifying that the information has not been altered. Source verifications can confirm the authenticity of the data by cross-referencing it with known and trusted sources, such as financial institutions, regulatory bodies, or market data providers. In some implementations, the smart contract validation information can be embedded within the smart contract, allowing the distributed ledger to autonomously verify the accuracy and authenticity of the off-chain data before executing any exchange. In some implementations, in response to receiving the smart contract validation information, the processor can verify the accuracy and integrity of the smart contract validation information. For example, the processor can cross-check the timestamps with the current system time to confirm data relevancy. In another example, the processor can compare the cryptographic hashes with the expected hash values to validate data integrity. In some implementations, once validation is complete, the processor can proceed to execute the exchange conversion from the first currency to the second currency.

For example, the indication received from the smart contracts can be based on a distributed schedule or an exchange rate threshold being met. If the indication is based on a distributed schedule, the smart contracts may be programmed to initiate an exchange on specific dates, such as the end of each fiscal quarter or upon reaching the maturity dates of specific financial instruments. If the indication is triggered by an exchange rate reaching a predefined threshold, the smart contracts can actively monitor live exchange rates through integrated data feeds. Once the exchange rate meets or exceeds the set threshold favorable to the transaction conditions, the smart contracts can automatically trigger the exchange conversion.

As shown in blocks 410-440, the processors can execute a sequence of operations to manage currency exchange transactions within a provider system. At block 410, processors identify and can securitize various assets linked to specific currencies. These assets, categorized within an asset grouping framework, can be managed according to predefined distribution parameters and schedules. At block 420, the processors can generate smart contracts that contain executable code to monitor off-chain conditions affecting these assets, such as exchange rate fluctuations or specific financial indices. The smart contracts can automate responses to market conditions. At block 430, these smart contracts can be broadcast to a single distributed ledger (e.g., FIG. 1B) or across multiple distributed ledgers (e.g., FIG. 1A)—implemented for different asset or currency types but interconnected to operate together. The broadcasting can maintain consistency and transparency across some or all transaction nodes. At block 440, the processors can receive signals from the smart contracts when set conditions are met, such as a favorable exchange rate or a scheduled distribution event. That is, the processors can activate the execution of currency exchanges or other specified transactions in the smart contracts (described in blocks 450-460), completing the operational cycle for efficient market responsiveness. For example, when a securitized asset involves multiple currencies, such as USD and JPY (e.g., USD received by obligee, JPY paid out to the investors), the processors can facilitate a bond issuance with these currencies. Smart contracts can be used to monitor exchange rates and trigger currency conversions for paying dividends or returns to investors when rates meet set thresholds or when payout dates arrive.

At block 450, the processors (e.g., exchange system 118) can, in response to the indication by the one or more smart contracts, process an exchange conversion from the first currency to the second currency based on the current exchange rate. For example, the exchange conversion can include calculating the equivalent value of the first currency in the second currency based on the received rate. In some implementations, processing the exchange conversion includes updating a plurality of ledger balances to reflect a pending exchange and temporarily locking exchange funds. For example, updating the ledger balance can include debiting the first currency and crediting an equivalent amount of the second currency in respective wallets on the ledger. In some implementations, the processing can achieve instant settlement of funds, using the processors implementation to facilitate the processing of multiple currencies and making the currencies fungible through a unified view of source and database.

In some implementations, temporarily locking the exchange funds includes generating an escrow condition in the one or more distributed ledgers and marking the exchange funds as unavailable for other exchanges until the transfer or a cancelation event is confirmed. For example, an escrow condition may be created to securely hold the funds while awaiting final confirmation of the exchange. In some implementations, temporarily locking the exchange funds involves creating an escrow condition on the distributed ledgers, ensuring that funds are reserved specifically for the transaction at hand. For example, marking the exchange funds as unavailable prevents them from being used in any other transactions until either the completion of the transfer or a cancellation event occurs. In some implementations, an escrow condition can be generated on the distributed ledgers to manage and secure exchange funds during a transaction. For example, the escrow condition can be set to verify that funds are only released when some or all transaction conditions are confirmed as met.

In some implementations, the processors can lock the current exchange rate prior to processing the exchange conversion by capturing and recording the current exchange rate at a point in time determined by the one or more smart contracts. For example, capturing and recording can include securing a snapshot of the exchange rate from a trusted data source at the transaction initiation moment. That is, locking can include embedding this rate into the transaction logic to maintain consistency through the transaction process. Furthermore, capturing the current exchange rate can include querying one or more of the plurality of off-chain data feeds for the most reliable and recent data. For example, exchange smart contracts can automate queries to these feeds at predetermined intervals or in response to market event triggers. In some implementations, locking includes embedding the current exchange rate into a transaction block that is verified and appended to the one or more distributed ledgers. For example, embedding can include programming the smart contract to integrate the rate into the transaction metadata. That is, a transaction block can be constructed to encapsulate some or all pertinent transaction details along with the locked rate. Furthermore, verifying and appending to the distributed ledger may include consensus checks among network nodes to validate the transaction block's integrity and accuracy. For example, blockchain protocols such as Proof of Work or Proof of Stake may be employed to achieve consensus and ledger finality.

In some implementations, processing the exchange conversion to the second currency is further responsive to satisfying the one or more distribution parameters of the receiving party. For example, satisfying the one or more distribution parameters may include confirming that the transaction meets or exceeds the minimum distribution value set by the receiving party. In some implementations, the one or more distribution parameters can include at least one of a minimum distribution value, a predefined transaction frequency, or a specific date of transfer. For example, the minimum distribution value may be set a certain financial threshold such as a denomination amount. In another example, the predefined transaction frequency may be set to monthly to align with the investor's cash flow needs. In another example, the specific date of transfer may be the end of each fiscal quarter to coincide with the receiving party's financial reporting periods. In some implementations, locking the current exchange rate before processing the exchange conversion can include the processors capturing and recording the rate at a moment as specified by the smart contracts. For example, capturing the current exchange rate can include querying off-chain data feeds to obtain the most accurate and up-to-date financial information. In some implementations, locking the exchange rate includes embedding this rate into a transaction block, which is then subject to verification and appending to the distributed ledgers.

At block 460, the processors (e.g., exchange system 118) can transfer the second currency to a wallet of the receiving party. That is, transferring may be performed within the processing step or as a separate operation depending on the system configuration. For example, processing can be different from transferring in that it includes the conversion calculations and ledger updates, while transferring moves the currency to the designated wallet. In some implementations, transferring can include validating a wallet credential of the receiving party and executing a confirmed ledger exchange to finalize the pending exchange. For example, validating the wallet credential can verify that the currency reaches the correct recipient and prevents fraud. Additionally, transferring the second currency to the wallet of the receiving party can include performing, using a cross-ledger protocol, a cross-ledger exchange from the one or more distributed ledgers to the wallet on a different distributed ledger. For example, this process may include cryptographic signatures to authenticate the transfer. In some implementations, the cross-ledger protocol can include initiating a cryptographic validation confirming the transfer on the one or more distributed ledgers and the different distributed ledger. For example, this step may use blockchain bridging technologies that facilitate asset transfers between disparate blockchain systems.

In some implementations, transferring the second currency to the wallet of the receiving party includes the use of a cross-ledger protocol to facilitate the exchange from the distributed ledgers to a wallet on a distinct distributed ledger. That is, the cross-ledger protocol can include initiating a cryptographic validation to confirm the transfer across the involved distributed ledgers. In some implementations, hash-locks can be used as a cross-ledger protocol through Hashed Timelock Contracts (HTLCs). In this implementation, a cryptographic hash function can secure the transaction, and funds are locked in a contract across different ledgers. The transaction can be completed only when the receiving party submits the correct cryptographic proof within a specified time frame. For example, in a transaction between two parties using separate ledgers, the sending party can generate a secret and its hash. The hash is used to lock the funds (e.g., converted funds from distribution) on the sender's ledger (e.g., exchange ledger 122). Once the funds are locked, the receiver (e.g., receiving party) can provide the original secret to unlock and claim the funds on their own ledger (e.g., exchange ledger 124). This process can improve the security of the transaction, as the funds cannot be released without the correct secret, and both parties must fulfill their parts of the contract within the time limit specified in the HTLC.

In some implementations, a real-time dashboard can display the credit/debit of funds (e.g., on a user device) which can provide visibility and immediate responsiveness of the processors to currency fluctuations. In some implementations, the processors can generate and embed identifiers to exchanges to determine the timing of exchange. Additionally, the processors can flag transactions that do not align with predetermined timelines, such as funds sent near the cutoff time that should count for the next day, aiding in arbitrage prevention. Furthermore, it should be understood that the smart contracts implemented by the processors can provide operational enforcement but also facilitate reconciliation across multiple blockchain systems.

As shown in blocks 450-460, the processors can manage and facilitate currency exchanges based on conditions defined by smart contracts. At block 450, upon receiving an indication from the smart contracts that predefined conditions are met—either a specific time scheduled for distribution or a favorable exchange rate or another condition—processors initiate the exchange conversion. The conversion can calculate the value of the first currency into the second based on the current exchange rate, updating ledger balances to reflect this transition and temporarily locking the exchange funds to ensure transaction integrity. At block 460, the processors can transfer the converted currency to the recipient's wallet. Transferring can include validating the credentials of the receiving wallet to confirm the transfer's destination and executing a ledger exchange to complete the transaction. A cross-ledger protocol (e.g., Polkadot, Cosmos, Interledger Protocol (ILP), etc.) can be used to facilitate the transfer, utilizing cryptographic validations to ensure the security and integrity of the exchange across different blockchain systems. For example, if the exchange is triggered by achieving a predefined EUR to USD exchange rate, the processors can convert the necessary amount, update the ledger to show this transaction, and secure the funds temporarily. After verifying that some or all conditions are met, the processors can execute the transfer to the investor's wallet, potentially including cross-ledger activities if the investor's wallet operates on a different blockchain system (e.g., from exchange ledger 122 to exchange ledger 124).

In some implementations, from the user computing system perspective, the user may request one or more assets that have already been securitized, such as bonds or other financial instruments, and categorized within an asset grouping framework. These assets can be identified by the wallet system 142, which interfaces with the analysis system 110 (e.g., of method 400) to retrieve and present relevant information to the user. The user can then specify preferences for currency distribution, such as choosing to receive returns in a preferred currency. The wallet system 142 can provide the user with information of the assets, including the associated distribution schedules and currencies involved. Once the user selects the desired assets and specifies their preferences, the wallet system 142 can communicate with the processors of method 400 to verify the preferences are implemented. The wallet system 142 can display the predefined distribution parameters, outlining the timing, amount, and type of currency for the distributions. For example, the user might select assets that distribute returns quarterly in USD, even though the original asset distributions are in EUR. The wallet system 142 can provide details and monitoring information to the user and can facilitate adjustments by the user. In some implementations, the wallet system 142 can provide the user with real-time updates on the performance of the selected assets and the status of currency conversions. The processors of method 400 can perform the execution of smart contracts and currency exchanges based on the predefined conditions set by the user. The wallet system 142 can receive notifications from the backend when these conditions are met, such as a favorable exchange rate or a scheduled distribution event. The converted funds can then be reflected in the user's wallet balance, allowing the user to manage their investments and track their financial returns efficiently. The wallet system 142 can also facilitates=the secure transfer of converted funds to the user's designated accounts.

In block 410, from the wallet system's perspective, method 400 can begin when the user requests information on securitized assets. The user computing system 140 can interface with the analysis system 110 to retrieve a list of available assets, categorized within an asset grouping framework. The user can view information about each asset, including its performance history, distribution schedules, and the currencies in which distributions are made. For example, a user might see options for bonds that pay quarterly dividends in EUR. The wallet system 142 can present this information in a graphical user interface, allowing the user to compare different assets and make informed decisions. Once the user selects an asset, the user can specify their preference for receiving distributions in a different currency, such as USD. The wallet system 142 communicates this preference to the processors of analysis system 110 for implementation.

At block 420, the user computing system 140 can verify that the user's preferences are transmitted to the analysis system 110. For example, the wallet system 142 can communicate with the processors to confirm that the selected assets are securitized and that the distribution parameters are set according to the user's specifications. For example, the user may prefer that dividends from a selected bond, originally in EUR, be converted to USD before being credited to their wallet. The wallet system 142 displays these parameters, showing the user the expected timing and amount of distributions. The wallet system 142 can provide real-time monitoring, so the user can see updates on asset performance and currency conversion status. If market conditions change, the user can adjust their preferences through the wallet system 142, which then updates the analysis system 110 accordingly

In blocks 430 to 460, the wallet system 142 can continue to provide the user with up-to-date information and facilitates secure transactions. When the conditions set by the user, such as a favorable exchange rate or a scheduled distribution date, are met, the processors of method 400 can execute the smart contracts and currency exchanges. For example, if the user has specified that they want to convert EUR dividends to USD whenever the exchange rate is above a certain threshold, the wallet system 142 will notify the user when this condition is met. The backend processors perform the exchange and update the user's wallet balance. The wallet system 142 reflects these updates, showing the user the converted funds in real-time. Additionally, the wallet system 142 can verify that the transferred funds are securely deposited into the user's designated accounts. For example, after converting EUR to USD, the wallet system 142 updates the user's balance and securely transfers the funds to their linked bank account.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include software for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

Accordingly, the “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may include or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the embodiments might include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions include, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, some or all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure may be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A method, comprising:
identifying, by one or more processing circuits, one or more assets of an asset class corresponding to an asset grouping framework, wherein the one or more assets corresponds to a right to performance in a first currency from one or more entities, and wherein the one or more assets comprise one or more distribution parameters corresponding to a distribution in a second currency to a receiving party based on a predefined distribution schedule;
generating, by the one or more processing circuits, one or more smart contracts comprising executable code to monitor an off-chain condition of the one or more assets and an exchanges rate between the first currency and the second currency, wherein the off-chain condition corresponds to a plurality of access locations for a plurality of off-chain data feeds that are accessed by the one or more smart contracts;
broadcasting, by the one or more processing circuits, the one or more smart contracts to one or more distributed ledgers, wherein broadcasting comprises propagating the one or more smart contracts to a plurality of network nodes through a consensus mechanism;
receiving, by the one or more processing circuits and from the one or more smart contracts, an indication that the off-chain condition is satisfied, wherein the indication comprises a current exchange rate between the first currency and the second currency, and wherein the indication further comprises smart contract validation information corresponding to at least one timestamp and at least one source verification of the plurality of off-chain data feeds;
in response to the indication by the one or more smart contracts, processing, by the one or more processing circuits, an exchange conversion from the first currency to the second currency based on the current exchange rate, wherein processing the exchange conversion comprises updating a plurality of ledger balances and to reflect a pending exchange and temporarily locking exchange funds; and
transferring, by the one or more processing circuits, the second currency to a wallet of the receiving party, wherein transferring comprises validating a wallet credential of the receiving party and executing a confirmed ledger exchange to finalize the pending exchange.

2. The method of claim 1, wherein identifying the one or more assets comprises:
securitizing, by the one or more processing circuits, the one or more assets;
determining, by the one or more processing circuits, a projected distribution at the predefined distribution schedule of the one or more assets, wherein the projected distribution is stored in the off-chain condition on the one or more distributed ledgers, wherein the projected distribution is in the second currency;
transmitting, by the one or more processing circuits, the projected distribution at the predefined distribution schedule in the second currency to a receiving party computing system; and
receiving, by the one or more processing circuits, a signed agreement corresponding to the projected distribution and the predefined distribution schedule in the second currency.

3. The method of claim 1, wherein:
a first smart contract of the one or more smart contracts monitors the one or more assets on a first ledger of the one or more distributed ledgers;
a second smart contract of the one more ore smart contract monitors the exchange rates on a second ledger of the one or more distributed ledgers; and
wherein the executable code is compatible with the first ledger and the second ledger.

4. The method of claim 1, wherein:
a first smart contract of the one or more smart contracts monitors the one or more assets on a first ledger of the one or more distributed ledgers;
a second smart contract of the one more ore smart contract monitors the exchange rates on the first ledger of the one or more distributed ledgers; and
wherein the executable code is compatible with the first ledger.

5. The method of claim 1, further comprising:
determining, by the one or more processing circuits, a first access location of the plurality of access locations of a first data feed of the plurality of off-chain data feeds corresponding to the one or more assets; and
determining, by the one or more processing circuits, a second access location of the plurality of access locations of a second data feed of the plurality of off-chain data feeds corresponding to the exchanges rates between the first currency and the second currency.

6. The method of claim 1, further comprising:
locking, by the one or more processing circuits, the current exchange rate prior to processing the exchange conversion by capturing and recording the current exchange rate at a point in time determined by the one or more smart contracts, wherein capturing the current exchange rate comprises querying one or more of the plurality of off-chain data feeds, and wherein locking comprises embedding the current exchange rate into a transaction block that is verified and appended to the one or more distributed ledgers; and
wherein processing the exchange conversion to the second currency is further responsive to satisfying the one or more distribution parameters of the receiving party, wherein the one or more distribution parameters comprise at least one of a minimum distribution value, a predefined transaction frequency, or a specific date of transfer.

7. The method of claim 6, further comprising:
determining, by the one or more processing circuits, the one or more distribution parameters of the receiving party based on inputting historical exchange data and a receiving party profile into a trained artificial intelligence (AI) model and receiving the one or more distribution parameters as an output.

8. The method of claim 1, wherein generating the one or more smart contracts further comprise generating a future contract for a future exchange rate at the predefined distribution schedule, wherein the future contract locks the future exchange rate for the exchange conversion, and wherein the current exchange rate is the future exchange rate of the future contract.

9. The method of claim 1, wherein:
broadcasting comprises signing and verifying the one or more smart contracts before storing the one or more smart contracts on the one or more distributed ledgers; and
transferring the second currency to the wallet of the receiving party comprises performing, using a cross-ledger protocol, a cross-ledger exchange from the one or more distributed ledgers to the wallet on a different distributed ledger, wherein the cross-ledger protocol comprises initiating a cryptographic validation confirming the transfer on the one or more distributed ledgers and the different distributed ledger.

10. The method of claim 1, wherein:
the first currency is at least one of a first type of fiat currency, digital currency, utility token, or cryptocurrency;
the second currency is at least one of a second type of fiat currency, digital currency, utility token, or cryptocurrency; and
wherein temporarily locking the exchange funds comprises generating an escrow condition in the one or more distributed ledgers and marking the exchange funds as unavailable for other exchanges until the transfer or a cancelation event is confirmed.

11. A system, comprising:
an data processing system comprising at least one processing circuit comprising at least one memory coupled to at least one processor, the at least one processing circuit of the data processing system configured to:
identify one or more assets of an asset class corresponding to an asset grouping framework, wherein the one or more assets corresponds to a right to performance in a first currency from one or more entities, and wherein the one or more assets comprise one or more distribution parameters corresponding to a distribution in a second currency to a receiving party based on a predefined distribution schedule;
generate one or more smart contracts comprising executable code to monitor an off-chain condition of the one or more assets and an exchanges rate between the first currency and the second currency, wherein the off-chain condition corresponds to a plurality of access locations for a plurality of off-chain data feeds accessible for monitoring by the one or more smart contracts;
broadcast the one or more smart contracts to one or more distributed ledgers, wherein broadcasting comprises propagating the one or more smart contracts to a plurality of network nodes through a consensus mechanism;
receive, from the one or more smart contracts, an indication that the off-chain condition is satisfied, wherein the indication comprises a current exchange rate between the first currency and the second currency, and wherein the indication further comprises smart contract validation information corresponding to at least one timestamp and at least one source verification of the plurality of off-chain data feeds;
in response to the indication by the one or more smart contracts, process an exchange conversion from the first currency to the second currency based on the current exchange rate, wherein processing the exchange conversion comprises updating a plurality of ledger balances and to reflect a pending exchange and temporarily locking exchange funds; and
transferring, by the one or more processing circuits, the second currency to a wallet of the receiving party, wherein transferring comprises validating a wallet credential of the receiving party and executing a confirmed ledger exchange to finalize the pending exchange.

12. The system of claim 11, wherein identifying the one or more assets comprises:
securitizing the one or more assets;
determining a projected distribution at the predefined distribution schedule of the one or more assets, wherein the projected distribution is stored in the off-chain condition on the one or more distributed ledgers, wherein the projected distribution is in the second currency;
transmitting the projected distribution at the predefined distribution schedule in the second currency to a receiving party computing system; and
receiving a signed agreement corresponding to the projected distribution and the predefined distribution schedule in the second currency.

13. The system of claim 11, wherein:
a first smart contract of the one or more smart contracts monitors the one or more assets on a first ledger of the one or more distributed ledgers;
a second smart contract of the one more ore smart contract monitors the exchange rates on a second ledger of the one or more distributed ledgers; and
wherein the executable code is compatible with the first ledger and the second ledger.

14. The system of claim 11, wherein:
a first smart contract of the one or more smart contracts monitors the one or more assets on a first ledger of the one or more distributed ledgers;
a second smart contract of the one more ore smart contract monitors the exchange rates on the first ledger of the one or more distributed ledgers; and
wherein the executable code is compatible with the first ledger.

15. The system of claim 11, the one or more processing circuits further configured to:
determine a first access location of the plurality of access locations of a first data feed of the plurality of off-chain data feeds corresponding to the one or more assets; and
determine a second access location of the plurality of access locations of a second data feed of the plurality of off-chain data feeds corresponding to the exchanges rates between the first currency and the second currency.

16. The system of claim 11, wherein the one or more processing circuits further configured to:
lock the current exchange rate prior to processing the exchange conversion by capturing and recording the current exchange rate at a point in time determined by the one or more smart contracts, wherein capturing the current exchange rate comprises querying one or more of the plurality of off-chain data feeds, and wherein locking comprises embedding the current exchange rate into a transaction block that is verified and appended to the one or more distributed ledgers; and
wherein processing the exchange conversion to the second currency is further responsive to satisfying the one or more distribution parameters of the receiving party, wherein the one or more distribution parameters comprise at least one of a minimum distribution value, a predefined transaction frequency, or a specific date of transfer.

17. The system of claim 16, wherein the one or more processing circuits further configured to:
determine the one or more distribution parameters of the receiving party based on inputting historical exchange data and a receiving party profile into a trained artificial intelligence (AI) model and receiving the one or more distribution parameters as an output.

18. The system of claim 11, wherein generating the one or more smart contracts further comprise generating a future contract for a future exchange rate at the predefined distribution schedule, wherein the future contract locks the future exchange rate for the exchange conversion, wherein the current exchange rate is the future exchange rate of the future contract.

19. A non-transitory computer readable medium (CRM) comprising one or more instructions stored thereon that, when executed by at least one processing circuit, cause the at least one processing circuit to perform operations comprising:
identifying one or more assets of an asset class corresponding to an asset grouping framework, wherein the one or more assets corresponds to a right to performance in a first currency from one or more entities, and wherein the one or more assets comprise one or more distribution parameters corresponding to a distribution in a second currency to a receiving party based on a predefined distribution schedule;
generating one or more smart contracts comprising executable code to monitor an off-chain condition of the one or more assets and exchanges rates between the first currency and the second currency, wherein the off-chain condition correspond to a plurality of access locations to a plurality of off-chain data feeds accessible for monitoring by the one or more smart contracts;
broadcasting the one or more smart contracts to one or more distributed ledgers, wherein broadcasting comprises propagating the one or more smart contracts to a plurality of network nodes through a consensus mechanism;
receiving, from the one or more smart contracts, an indication the off-chain condition is satisfied, wherein the indication comprises a current exchange rate between the first currency and the second currency, and wherein the indication further comprises smart contract validation information corresponding to at least one timestamp and at least one source verification of the plurality of off-chain data feeds;
in response to the indication by the one or more smart contracts, processing an exchange conversion from the first currency to the second currency based on the current exchange rate, wherein processing the exchange conversion comprises updating a plurality of ledger balances and to reflect a pending exchange and temporarily locking exchange funds; and
transferring the second currency to a wallet of the receiving party, wherein transferring comprises validating a wallet credential of the receiving party and executing a confirmed ledger exchange to finalize the pending exchange.

20. The non-transitory CRM of claim 19, wherein the one or more instructions, when executed by the one or more processing circuits, further cause the one or more processing circuits to perform operations comprising:
securitizing the one or more assets;
determining a projected distribution at the predefined distribution schedule of the one or more assets, wherein the projected distribution is stored in the off-chain condition on the one or more distributed ledgers, wherein the projected distribution is in the second currency;
transmitting the projected distribution at the predefined distribution schedule in the second currency to a receiving party computing system; and
receiving a signed agreement corresponding to the projected distribution and the predefined distribution schedule in the second currency.
